(19) United States
(12) Patent Application Publication
(10) Pub. No.: US 2026/0082387 A1
(43) Pub. Date: Mar. 19, 2026

(54) DYNAMIC CODEBOOK FOR MAPPING FEEDBACK TO MULTIPLE SLOTS

(71) Applicant: QUALCOMM Incorporated, San Diego, CA (US)

(72) Inventors: Mostafa KHOSHNEVISAN, San Diego, CA (US); Jing SUN, San Diego, CA (US); Kianoush HOSSEINI, San Diego, CA (US); Jing JIANG, San Diego, CA (US)

(21) Appl. No.: 18/890,611

(22) Filed: Sep. 19, 2024

(51) Int. Cl. H04W 72/1273; H04W 72/0446; H04W 72/231; H04W 74/0816

(52) U.S. Cl. CPC H04W 72/1273; H04W 72/0446; H04W 72/231; H04W 74/0816

(57) ABSTRACT

Methods, systems, and devices for wireless communications are described. A wireless communications system may support transmission of feedback information for downlink data information in multiple feedback payloads across multiple uplink channel slots. A user equipment (UE) may transmit an acknowledgement for a downlink shared channel message in multiple feedback payloads across multiple different uplink control channel transmission occasions, the payloads being different. For a given downlink shared channel message, a UE may report associated feedback in two or more uplink control channel transmission occasions. The payloads reported in the two or more uplink control channel transmission occasions may be overlapping (e.g., have at least one feedback bit in common) but not the same. The UE may generate the feedback payloads based on downlink assignment indicator (DAI) values indicated by downlink control information (DCI) that schedules a downlink channel transmission.

### INTRODUCTION

The following relates to wireless communications that pertain to feedback mapping. Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method of wireless communication performed by a network entity is described. The method may include receiving a first downlink control information (DCI) that schedules a first downlink shared channel transmission, where the first DCI indicates a first downlink assignment indicator (DAI) value for first feedback information associated with the first downlink shared channel transmission, transmitting, during a first uplink channel transmission occasion and based on the first DAI value, a first payload that includes the first feedback information associated with the first downlink shared channel transmission at a first location of a first codebook, receiving a second DCI that schedules a second downlink shared channel transmission, where the second DCI indicates a second DAI value for second feedback information associated with the second downlink shared channel transmission, and transmitting, during a second uplink channel transmission occasion and based on the first DAI value and the second DAI value, a second payload that includes the first feedback information at a second location of a second codebook and the second feedback information at a third location of a third codebook, where the second payload includes the second codebook concatenated with the third codebook.

A network entity for wireless communication is described. The network entity may include one or more memories storing processor executable code, and one or more processors coupled with the one or more memories. The one or more processors may individually or collectively be operable to execute the code to cause the network entity to receive a first DCI that schedules a first downlink shared channel transmission, where the first DCI indicates a first DAI value for first feedback information associated with the first downlink shared channel transmission, transmit, during a first uplink channel transmission occasion and based on the first DAI value, a first payload that includes the first feedback information associated with the first downlink shared channel transmission at a first location of a first codebook, receive a second DCI that schedules a second downlink shared channel transmission, where the second DCI indicates a second DAI value for second feedback information associated with the second downlink shared channel transmission, and transmit, during a second uplink channel transmission occasion and based on the first DAI value and the second DAI value, a second payload that includes the first feedback information at a second location of a second codebook and the second feedback information at a third location of a third codebook, where the second payload includes the second codebook concatenated with the third codebook.

Another network entity for wireless communication is described. The network entity may include means for receiving a first DCI that schedules a first downlink shared channel transmission, where the first DCI indicates a first DAI value for first feedback information associated with the first downlink shared channel transmission, means for transmitting, during a first uplink channel transmission occasion and based on the first DAI value, a first payload that includes the first feedback information associated with the first downlink shared channel transmission at a first location of a first codebook, means for receiving a second DCI that schedules a second downlink shared channel transmission, where the second DCI indicates a second DAI value for second feedback information associated with the second downlink shared channel transmission, and means for transmitting, during a second uplink channel transmission occasion and based on the first DAI value and the second DAI value, a second payload that includes the first feedback information at a second location of a second codebook and the second feedback information at a third location of a third codebook, where the second payload includes the second codebook concatenated with the third codebook.

A non-transitory computer-readable medium storing code for wireless communication is described. The code may include instructions executable by one or more processors to receive a first DCI that schedules a first downlink shared channel transmission, where the first DCI indicates a first DAI value for first feedback information associated with the first downlink shared channel transmission, transmit, during a first uplink channel transmission occasion and based on the first DAI value, a first payload that includes the first feedback information associated with the first downlink shared channel transmission at a first location of a first codebook, receive a second DCI that schedules a second downlink shared channel transmission, where the second DCI indicates a second DAI value for second feedback information associated with the second downlink shared channel transmission, and transmit, during a second uplink channel transmission occasion and based on the first DAI value and the second DAI value, a second payload that includes the first feedback information at a second location of a second codebook and the second feedback information at a third location of a third codebook, where the second payload includes the second codebook concatenated with the third codebook.

In some examples of the method, network entities, and non-transitory computer-readable medium described herein, the first DAI value indicates a first location of the first feedback information within the first uplink channel transmission occasion and the second DAI value indicates a second location of the second feedback information within the second uplink channel transmission occasion.

In some examples of the method, network entities, and non-transitory computer-readable medium described herein, the first DAI value indicates a location of the first feedback information within the second uplink channel transmission occasion.

In some examples of the method, network entities, and non-transitory computer-readable medium described herein, the second payload includes the second feedback information concatenated to an end of the first feedback information.

In some examples of the method, network entities, and non-transitory computer-readable medium described herein, the second payload includes the second feedback information concatenated to a beginning of the first feedback information.

In some examples of the method, network entities, and non-transitory computer-readable medium described herein, the second payload includes the second codebook that includes a second report of the first feedback information and the third codebook that includes a first report of the second feedback information.

In some examples of the method, network entities, and non-transitory computer-readable medium described herein, the first DCI indicates a set of DAI values including the first DAI value and a third DAI value and the third DAI value may be associated with the second uplink channel transmission occasion.

Some examples of the method, network entities, and non-transitory computer-readable medium described herein may further include operations, features, means, or instructions for receiving a third DCI that schedules a third downlink shared channel transmission, where the third DCI indicates a third DAI value for third feedback information associated with the third downlink shared channel transmission and transmitting, during a third uplink channel transmission occasion, a third payload that includes the second feedback information at a fourth location of a fourth codebook and the third feedback information at a fifth location of a fifth codebook based on the second DAI value and the third DAI value, where the third payload includes the fourth codebook concatenated with the fifth codebook.

In some examples of the method, network entities, and non-transitory computer-readable medium described herein, a location of the third feedback information within the third uplink channel transmission occasion may be based on a difference between the third DAI value and a highest DAI value among a set of DAI values associated with the first payload.

In some examples of the method, network entities, and non-transitory computer-readable medium described herein, the second DAI value corresponds to a location of the second feedback information within a subset of feedback bits of the second payload.

In some examples of the method, network entities, and non-transitory computer-readable medium described herein, the second DAI value corresponds to a location of the second feedback information within all feedback bits of the second payload.

In some examples of the method, network entities, and non-transitory computer-readable medium described herein, an ordering of the first feedback information within the first uplink channel transmission occasion may be based on a timing of a set of DCI that schedules a downlink shared channel transmission, including the first DCI that schedules the first downlink shared channel transmission.

A method of wireless communication performed by a network entity is described. The method may include outputting a first DCI that schedules a first downlink shared channel transmission, where the first DCI indicates a first DAI value for first feedback information associated with the first downlink shared channel transmission, obtaining, during a first uplink channel transmission occasion and based on the first DAI value, a first payload that includes the first feedback information for the first downlink shared channel transmission at a first location of a first codebook, outputting a second DCI that schedules a second downlink shared channel transmission, where the second DCI indicates a second DAI value for second feedback information associated with the second downlink shared channel transmission, and obtaining, during a second uplink channel transmission occasion and based on the first DAI value and the second DAI value, a second payload that includes the first feedback information at a second location of a second codebook and the second feedback information at a third location of a third codebook, where the second payload includes the second codebook concatenated with the third codebook.

A network entity for wireless communication is described. The network entity may include one or more memories storing processor executable code, and one or more processors coupled with the one or more memories. The one or more processors may individually or collectively be operable to execute the code to cause the network entity to output a first DCI that schedules a first downlink shared channel transmission, where the first DCI indicates a first DAI value for first feedback information associated with the first downlink shared channel transmission, obtain, during a first uplink channel transmission occasion and based on the first DAI value, a first payload that includes the first feedback information for the first downlink shared channel transmission at a first location of a first codebook, output a second DCI that schedules a second downlink shared channel transmission, where the second DCI indicates a second DAI value for second feedback information associated with the second downlink shared channel transmission, and obtain, during a second uplink channel transmission occasion and based on the first DAI value and the second DAI value, a second payload that includes the first feedback information at a second location of a second codebook and the second feedback information at a third location of a third codebook, where the second payload includes the second codebook concatenated with the third codebook.

Another network entity for wireless communication is described. The network entity may include means for outputting a first DCI that schedules a first downlink shared channel transmission, where the first DCI indicates a first DAI value for first feedback information associated with the first downlink shared channel transmission, means for obtaining, during a first uplink channel transmission occasion and based on the first DAI value, a first payload that includes the first feedback information for the first downlink shared channel transmission at a first location of a first codebook, means for outputting a second DCI that schedules a second downlink shared channel transmission, where the second DCI indicates a second DAI value for second feedback information associated with the second downlink shared channel transmission, and means for obtaining, during a second uplink channel transmission occasion and based on the first DAI value and the second DAI value, a second payload that includes the first feedback information at a second location of a second codebook and the second feedback information at a third location of a third codebook, where the second payload includes the second codebook concatenated with the third codebook.

A non-transitory computer-readable medium storing code for wireless communication is described. The code may include instructions executable by one or more processors to output a first DCI that schedules a first downlink shared channel transmission, where the first DCI indicates a first DAI value for first feedback information associated with the first downlink shared channel transmission, obtain, during a first uplink channel transmission occasion and based on the first DAI value, a first payload that includes the first feedback information for the first downlink shared channel transmission at a first location of a first codebook, output a second DCI that schedules a second downlink shared channel transmission, where the second DCI indicates a second DAI value for second feedback information associated with the second downlink shared channel transmission, and obtain, during a second uplink channel transmission occasion and based on the first DAI value and the second DAI value, a second payload that includes the first feedback information at a second location of a second codebook and the second feedback information at a third location of a third codebook, where the second payload includes the second codebook concatenated with the third codebook.

In some examples of the method, network entities, and non-transitory computer-readable medium described herein, the first DAI value indicates a first location of the first feedback information within the first uplink channel transmission occasion and the second DAI value indicates a second location of the second feedback information within the second uplink channel transmission occasion.

In some examples of the method, network entities, and non-transitory computer-readable medium described herein, the first DAI value indicates a location of the first feedback information within the second uplink channel transmission occasion.

In some examples of the method, network entities, and non-transitory computer-readable medium described herein, the second payload includes the second feedback information concatenated to an end of the first feedback information.

In some examples of the method, network entities, and non-transitory computer-readable medium described herein, the second payload includes the second feedback information concatenated to a beginning of the first feedback information.

In some examples of the method, network entities, and non-transitory computer-readable medium described herein, the second payload includes the second codebook that includes a second report of the first feedback information and the third codebook that includes a first report of the second feedback information.

In some examples of the method, network entities, and non-transitory computer-readable medium described herein, the first DCI indicates a set of DAI values including the first DAI value and a third DAI value and the third DAI value may be associated with the second uplink channel transmission occasion.

Some examples of the method, network entities, and non-transitory computer-readable medium described herein may further include operations, features, means, or instructions for outputting a third DCI that schedules a third downlink shared channel transmission, where the third DCI indicates a third DAI value for third feedback information associated with the third downlink shared channel transmission and obtaining, during a third uplink channel transmission occasion, a third payload that includes the second feedback information at a fourth location of a fourth codebook and the third feedback information at a fifth location of a fifth codebook based on the second DAI value and the third DAI value, where the third payload includes the fourth codebook concatenated with the fifth codebook.

In some examples of the method, network entities, and non-transitory computer-readable medium described herein, a location of the third feedback information within the third uplink channel transmission occasion may be based on a difference between the third DAI value and a highest DAI value among a set of DAI values associated with the first payload.

In some examples of the method, network entities, and non-transitory computer-readable medium described herein, the second DAI value corresponds to a location of the second feedback information within a subset of feedback bits of the second payload.

In some examples of the method, network entities, and non-transitory computer-readable medium described herein, the second DAI value corresponds to a location of the second feedback information within all feedback bits of the second payload.

In some examples of the method, network entities, and non-transitory computer-readable medium described herein, an ordering of the first feedback information within the first uplink channel transmission occasion may be based on a timing of a set of DCI that schedules a downlink shared channel transmission, including the first DCI that schedules the first downlink shared channel transmission.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports dynamic codebook for mapping feedback to multiple slots in accordance with one or more aspects of the present disclosure.

FIG. 2 shows an example of a wireless communications system that supports dynamic codebook for mapping feedback to multiple slots in accordance with one or more aspects of the present disclosure.

FIG. 3 shows an example of a DAI mapping scheme that supports dynamic codebook for mapping feedback to multiple slots in accordance with one or more aspects of the present disclosure.

FIG. 4 shows an example of a process flow that supports dynamic codebook for mapping feedback to multiple slots in accordance with one or more aspects of the present disclosure.

FIGS. 5 and 6 show block diagrams of devices that support dynamic codebook for mapping feedback to multiple slots in accordance with one or more aspects of the present disclosure.

FIG. 7 shows a block diagram of a communications manager that supports dynamic codebook for mapping feedback to multiple slots in accordance with one or more aspects of the present disclosure.

FIG. 8 shows a diagram of a system including a device that supports dynamic codebook for mapping feedback to multiple slots in accordance with one or more aspects of the present disclosure.

FIGS. 9 and 10 show block diagrams of devices that support dynamic codebook for mapping feedback to multiple slots in accordance with one or more aspects of the present disclosure.

FIG. 11 shows a block diagram of a communications manager that supports dynamic codebook for mapping feedback to multiple slots in accordance with one or more aspects of the present disclosure.

FIG. 12 shows a diagram of a system including a device that supports dynamic codebook for mapping feedback to multiple slots in accordance with one or more aspects of the present disclosure.

FIGS. 13 through 15 show flowcharts illustrating methods that support dynamic codebook for mapping feedback to multiple slots in accordance with one or more aspects of the present disclosure.

### DETAILED DESCRIPTION

A network entity may transmit downlink control information (DCI) via a physical downlink control channel (PDCCH) to schedule a physical downlink shared channel (PDSCH) for transmission of downlink data information to a user equipment (UE). The DCI may indicate a slot offset between a PDSCH slot carrying the downlink data information and a physical uplink control channel (PUCCH) slot the UE is to use to transmit hybrid automatic repeat request (HARQ) feedback for the downlink data information. In some wireless communications systems, a UE may be configured to transmit uplink control information, including HARQ feedback, over multiple PUCCH repetitions. However, some systems may not support multiplexing uplink control information on a physical uplink shared channel (PUSCH) or multiplexing uplink control information on a PUCCH. For uplink repetition, these restrictions may ensure the same payload and coded bits are transmitted across different PUCCH repetitions for soft combining at the network. Due to these restrictions, PUCCH repetition in these systems is not flexible.

A wireless communications system described herein supports transmission of feedback information for downlink data information in multiple feedback payloads across multiple PUCCH slots. A UE may transmit an acknowledgement for a downlink shared channel message in multiple feedback payloads across multiple different uplink control channel transmission occasions, but the payloads across the multiple different uplink slots may be different or not exactly the same. For a given downlink shared channel message, a UE may report associated feedback in two or more uplink control channel transmission occasions. The payload reported in the two or more uplink control channel transmission occasions are overlapping (e.g., have at least one feedback bit in common) but are not the same.

The UE may generate the feedback payloads based on downlink assignment indicator (DAI) values indicated by DCI that schedules PDSCH. In some examples, a DAI value in DCI scheduling a PDSCH may determine a location of the corresponding feedback bit in a first (e.g., earliest) PUCCH transmission occasion. The order may be kept in subsequent feedback payloads transmitted in subsequent PUCCH transmission occasions. For a PUCCH transmission occasion used to report multiple sets of feedback bits, the set feedback bits of the earlier PDSCH messages may be before or after the set of feedback bits of the later PDSCH messages. In some examples, DCI may indicate multiple DAI values, where the different DAI values indicate the position of the corresponding feedback bit in corresponding PUCCH transmission occasions. Additional techniques for constructing a feedback codebook are described.

Aspects of the disclosure are initially described in the context of wireless communications systems. Aspects of the disclosure are then described with reference to a DAI mapping scheme and a process flow. Aspects of the disclosure are further illustrated by and described with reference to apparatus diagrams, system diagrams, and flowcharts that relate to dynamic codebook for mapping feedback to multiple slots.

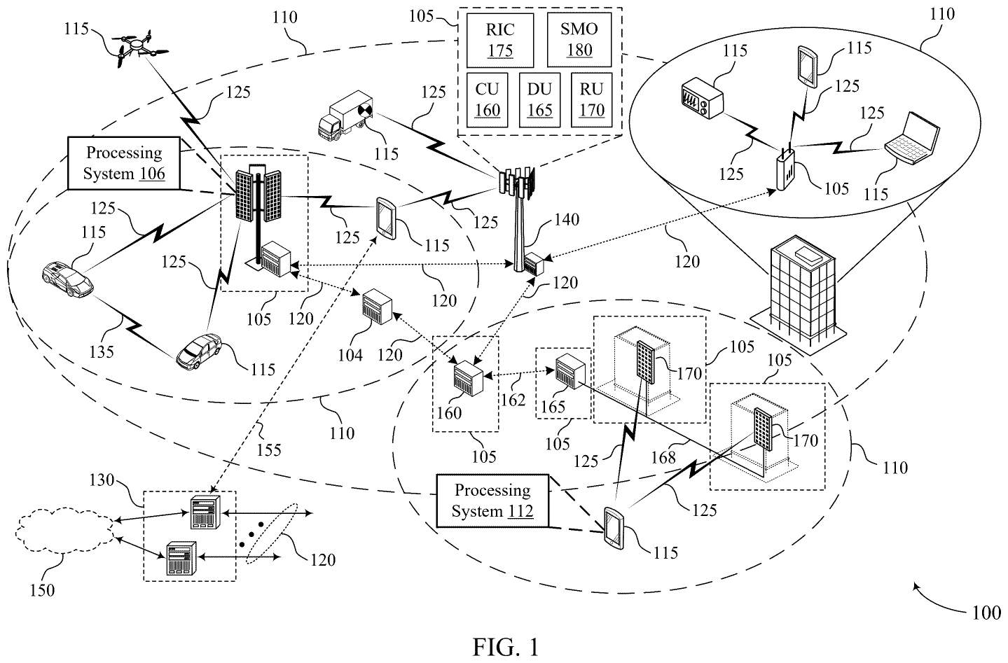

FIG. 1 shows an example of a wireless communications system 100 that supports dynamic codebook for mapping feedback to multiple slots in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a network entity (which may alternatively be referred to as an entity, a node, a network node, or a wireless entity) may be, be similar to, include, or be included in (e.g., be a component of) a base station (e.g., any base station described herein, including a disaggregated base station), a UE (e.g., any UE described herein), a reduced capability (RedCap) device, an enhanced reduced capability (eRedCap) device, an ambient internet-of-things (IoT) device, an energy harvesting (EH)-capable device, a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network entity may be a UE. As another example, a network entity may be a base station. As used herein, “network entity” may refer to an entity that is configured to operate in a network, such as the network 105. For example, a “network entity” is not limited to an entity that is currently located in and/or currently operating in the network. Rather, a network entity may be any entity that is capable of communicating and/or operating in the network.

The adjectives “first,” “second,” “third,” and so on are used for contextual distinction between two or more of the modified noun in connection with a discussion and are not meant to be absolute modifiers that apply only to a certain respective entity throughout the entire document. For example, a network entity may be referred to as a “first network entity” in connection with one discussion and may be referred to as a “second network entity” in connection with another discussion, or vice versa. As an example, a first network entity may be configured to communicate with a second network entity or a third network entity. In one aspect of this example, the first network entity may be a UE, the second network entity may be a base station, and the third network entity may be a UE. In another aspect of this example, the first network entity may be a UE, the second network entity may be a base station, and the third network entity may be a base station. In yet other aspects of this example, the first, second, and third network entities may be different relative to these examples.

Similarly, reference to a UE, base station, apparatus, device, computing system, or the like may include disclosure of the UE, base station, apparatus, device, computing system, or the like being a network entity. For example, disclosure that a UE is configured to receive information from a base station also discloses that a first network entity is configured to receive information from a second network entity. Consistent with this disclosure, once a specific example is broadened in accordance with this disclosure (e.g., a UE is configured to receive information from a base station also discloses that a first network entity is configured to receive information from a second network entity), the broader example of the narrower example may be interpreted in the reverse, but in a broad open-ended way. In the example above where a UE is configured to receive information from a base station also discloses that a first network entity is configured to receive information from a second network entity, the first network entity may refer to a first UE, a first base station, a first apparatus, a first device, a first computing system, a first set of one or more one or more components, a first processing entity, or the like configured to receive the information; and the second network entity may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network entity may be described as being configured to transmit information to a second network entity. In this example and consistent with this disclosure, disclosure that the first network entity is configured to transmit information to the second network entity includes disclosure that the first network entity is configured to provide, send, output, communicate, or transmit information to the second network entity. Similarly, in this example and consistent with this disclosure, disclosure that the first network entity is configured to transmit information to the second network entity includes disclosure that the second network entity is configured to receive, obtain, or decode the information that is provided, sent, output, communicated, or transmitted by the first network entity.

As shown, the network entity (e.g., network entity 105) may include a processing system 106. Similarly, the network entity (e.g., UE 115) may include a processing system 112. A processing system may include one or more components (or subcomponents), such as one or more components described herein. For example, a respective component of the one or more components may be, be similar to, include, or be included in at least one memory, at least one communication interface, or at least one processor. For example, a processing system may include one or more components. In such an example, the one or more components may include a first component, a second component, and a third component. In this example, the first component may be coupled to a second component and a third component. In this example, the first component may be at least one processor, the second component may be a communication interface, and the third component may be at least one memory. A processing system may generally be a system one or more components that may perform one or more functions, such as any function or combination of functions described herein. For example, one or more components may receive input information (e.g., any information that is an input, such as a signal, any digital information, or any other information), one or more components may process the input information to generate output information (e.g., any information that is an output, such as a signal or any other information), one or more components may perform any function as described herein, or any combination thereof. As described herein, an “input” and “input information” may be used interchangeably. Similarly, as described herein, an “output” and “output information” may be used interchangeably. Any information generated by any component may be provided to one or more other systems or components of, for example, a network entity described herein). For example, a processing system may include a first component configured to receive or obtain information, a second component configured to process the information to generate output information, and/or a third component configured to provide the output information to other systems or components. In this example, the first component may be a communication interface (e.g., a first communication interface), the second component may be at least one processor (e.g., that is coupled to the communication interface and/or at least one memory), and the third component may be a communication interface (e.g., the first communication interface or a second communication interface). For example, a processing system may include at least one memory, at least one communication interface, and/or at least one processor, where the at least one processor may, for example, be coupled to the at least one memory and the at least one communication interface.

A processing system of a network entity described herein may interface with one or more other components of the network entity, may process information received from one or more other components (such as input information), or may output information to one or more other components. For example, a processing system may include a first component configured to interface with one or more other components of the network entity to receive or obtain information, a second component configured to process the information to generate one or more outputs, and/or a third component configured to output the one or more outputs to one or more other components. In this example, the first component may be a communication interface (e.g., a first communication interface), the second component may be at least one processor (e.g., that is coupled to the communication interface and/or at least one memory), and the third component may be a communication interface (e.g., the first communication interface or a second communication interface). For example, a chip or modem of the network entity may include a processing system. The processing system may include a first communication interface to receive or obtain information, and a second communication interface to output, transmit, or provide information. In some examples, the first communication interface may be an interface configured to receive input information, and the information may be provided to the processing system. In some examples, the second system interface may be configured to transmit information output from the chip or modem. The second communication interface may also obtain or receive input information, and the first communication interface may also output, transmit, or provide information.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support dynamic codebook for mapping feedback to multiple slots as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

A UE 115 may transmit HARQ feedback via an uplink control channel, such as a physical uplink control channel (PUCCH). For example, a network entity 105 may transmit DCI via a downlink control channel, such as a physical downlink control channel (PDCCH), to schedule the UE 115 to receive a downlink data information via a downlink shared channel, such as a physical downlink shared channel (PDSCH). The DCI may include resource allocation information for the PDSCH and indicate a slot offset to the PUCCH for the HARQ feedback.

A UE 115 may monitor for control channel signaling during physical downlink control channel (PDCCH) monitoring occasions. PDCCH monitoring occasions may be based on a configuration of a search space set for a serving cell. For example, different search space set configurations for different serving cells may correspond to different PDCCH monitoring occasions for the different serving cells. If two search space sets (of the same or different serving cells) have a same start time, the two search space sets may be counted as one PDCCH monitoring occasion.

A network entity 105 may transmit DCI to a UE 115 including a DAI. For example, the UE 115 may receive a DAI via DCI, such as in a downlink grant for a PDSCH resource. A DCI may indicate a counter DAI (cDAI) or a total DAI (tDAI), or both. A cDAI may be an accumulative quantity of serving cell and PDCCH monitoring occasion pairs in which DCI has been sent by a network entity, including a current serving cell and current PDCCH monitoring occasion. A tDAI may correspond to a total quantity of serving cell and PDCCH monitoring occasion pairs in which DCI has been sent by the network entity 105, up to a current PDCCH monitoring occasion. The tDAI may be used for carrier aggregation with multiple serving cells. Downlink control information in the same PDCCH monitoring occasion may have the same tDAI value. In some examples, tDAI may provide protection against missed DCI corresponding to the last serving cell in the same PDCCH monitoring occasion. For both cDAI and tDAI fields in DCI, there may be a modulo 4 operation (e.g., two bits are used for each of cDAI and tDAI).

If a DCI transmission is not missed, an acknowledgement (ACK) or negative acknowledgment (NACK) corresponding to the received PDSCH is placed in a codebook in the same order as the cDAI. If a DCI transmission is missed, a NACK may be placed in the codebook in the same order as the missed cDAI.

In some examples, a UE 115 may determine that the UE 115 has missed a DCI transmission by comparing consecutive cDAI values. For example, the UE 115 may receive a first DCI message with a cDAI value of ‘1’, and the UE 115 may next receive a second DCI message with a cDAI value of ‘3’. The jump from ‘1’ to ‘3’ may be indicative that the UE 115 has missed a DCI message with a cDAI value of ‘2’.

In some examples, the UE 115 may determine the UE has missed a DCI message by comparing tDAI with cDAI of all DCI in the same PDCCH monitoring occasion. For example, for two serving cells in a PDCCH monitoring occasion, if the UE 115 has received only a single DCI with a cDAI value of ‘1’ and a tDAI value of ‘2’, the UE 115 may have missed a DCI.

In some examples, the DCI may include a parameter that indicates the slot offset to the PUCCH for the HARQ feedback. For example, a slot offset from a PDSCH slot to an uplink slot for HARQ feedback may be denoted by k₁. In some examples, the DCI may indicate a value for k₁. For example, one value of k₁ may be indicated by the DCI scheduling the PDSCH. In some cases, if there is only one k₁ value to indicate, the k₁ value may be configured via RRC signaling (e.g., without indication in DCI). In some cases, RRC signaling may configure a set of possible k_1 values from which one k_1 value is indicated by the DCI. If the DCI does not schedule a PDSCH but triggers HARQ feedback, k₁ may correspond to a slot offset from a PDCCH slot carrying the DCI to the PUCCH slot for HARQ feedback.

A UE 115 may determine a codebook via semi-static information based on candidate PDSCH occasions. In some cases, the UE 115 may not consider PDCCH monitoring occasions for a Type 1 HARQ feedback codebook. The set of PDSCH occasions may be determine on a per-downlink serving cell basis. A set of configured K₁ values may correspond to possible slot timing offset values, or offsets between a PDSCH slot and a slot where the UE 115 transmits HARQ feedback. Downlink control information may indicate one slot timing offset value, k₁, from the set of slot timing offset values K₁. For each k₁ value, PDSCH time domain resource allocation (TDRA) candidates that overlap with semi-static uplink symbols may be removed from a set of PDSCH time domain resource allocation (TDRA) candidates corresponding to a start and length indicator value (SLIV) in a slot. The remaining TDRA candidates or row may be grouped such that a quantity of groups is a maximum quantity of non-overlapping SLIVs in the slot. For example, the UE 115 may first perform PDSCH occasion determination and second perform HARQ-ACK codebook determination based on the PDSCH occasions.

In some cases, a UE 115 may be semi-statically or dynamically configured to transmit uplink control information over multiple PUCCH repetitions. The UE may use a same PUCCH resource across multiple slots or sub-slots. For a semi-static configuration of PUCCH repetition, a quantity of repetitions, N, may be configured as part of, or with, PUCCH formats. For example, a parameter, such as nrofSlots in a PUCCH-FormatConfig field, may indicate the quantity of repetitions for PUCCH repetition. PUCCH transmissions with the same format may use the same quantity of repetitions for PUCCH repetition. For dynamic configuration of PUCCH repetition, the quantity of repetitions may be configured per-PUCCH resource. A physical resource indicator may implicitly and dynamically indicate the quantity of repetitions, such as by pointing to a PUCCH resource that is RRC configured to be associated with a particular quantity of repetitions. Repetition counting toward N, the quantity of repetitions, may be based on available slot counting. A slot in which the symbols of the PUCCH resource overlap with semi-static downlink resources or SSB symbols may not be counted toward the N repetitions.

Some systems may implement restrictions for PUCCH repetition. For example, some systems may implement a first restriction to not support uplink control information multiplexing on a PUSCH. If a PUCCH repetition overlaps with a PUSCH, in a same or different uplink component carrier, the UE 115 may drop the PUSCH. In some examples, these systems may implement a second restriction to not support uplink control information multiplexing on a PUCCH. If multiple uplink control information are on overlapping resources, and at least one of the uplink control information is configured for PUCCH repetition, the UE 115 may drop PUCCH transmissions according to prioritization rules. For example, the UE 115 may drop lower priority PUCCH transmissions if multiple PUCCH transmissions would overlap in at least one slot, or the UE 115 may drop later PUCCH transmissions if overlapping PUCCH transmissions have a same priority.

These restrictions may ensure a same payload and same coded bits are transmitted in different PUCCH repetitions for soft combining at the network. For the first restriction, even if the same payload is separately encoded and multiplexed on a PUSCH, the UE 115 may use a same mother code with UCI is multiplexed on different PUSCHs, which is complex as the mother code may be based on multiple factors including PUSCH resources, beta offset, presence, size, and beta offset of other uplink control information multiplexed on the same PUSCH, and the like. For the second restriction, the mother code may need to be the same, but the uplink control information may also be separately encoded on a PUCCH resource. For example, a UE 115 may transmit first and second repetitions of a first uplink control information and first and second repetitions of a second uplink control information, where the second repetition of the first uplink control information and the first repetition of the second uplink control information overlap. In some current systems, the UE 115 may drop the first repetition of the second uplink control information. Without the second restriction or dropping the first repetition of the second uplink control information, the UE may separately encode the second repetition of the first uplink control information and the first repetition of the second uplink control information and transmit the second repetition of the first uplink control information and the first repetition of the second uplink control information on a same PUCCH resource, while ensuring that the mother code length remains the same for the different uplink control information across different repetitions after uplink control information multiplexing.

These restrictions may prevent PUCCH repetition from being flexible. However, even if the restrictions are relaxed, the network may either not schedule PDSCH in some of the downlink slots, impacting downlink throughput, or schedule HARQ feedback with delay to accommodate previous PUCCH repetitions.

The wireless communications system 100 supports techniques for a UE 115 to report HARQ feedback for a PDSCH in multiple HARQ-ACK payloads transmitted on different slots. The HARQ-ACK payloads may include some common information but may be different across the different slots. For example, the UE 115 may transmit HARQ feedback with incremental redundancy by incrementally changing the contents of a HARQ payload across PUCCH transmission occasions. Additional techniques are described for determining PUCCH slots for reporting a HARQ-ACK bit for a given PDSCH on the two or more PUCCH transmission occasions, multiplexing PUCCH with PUSCH and other uplink control information, determining a HARQ codebook for HARQ feedback with incremental redundancy, reporting capability information for HARQ feedback with incremental redundancy, and jointly decoding the HARQ feedback.

Some techniques may be based on available slots or slots that are available for uplink transmission. In some examples, a slot may be an available uplink slot if the slot includes at least one uplink symbol or at least one flexible symbol. In some examples, a slot may be an available uplink slot if all symbols of the slot are uplink symbols or flexible symbols (or a combination of uplink symbols and flexible symbols). In some examples, a slot may be an available uplink slot if all symbols of the PUCCH resource (e.g., that carries HARQ feedback) in that slot are either uplink symbols or flexible symbols.

Criteria for an available uplink slot may be configurable. For example, a network entity 105 may configure a UE 115 to consider a slot as available for uplink transmission if the slot includes one or more uplink or flexible symbols. In some examples, a slot may be considered as available for uplink transmission based on whether the slot at least partially overlaps with an SSB transmission, such as in addition to other criteria. For example, a UE 115 may determine a slot is available for uplink transmission if the slot includes at least one uplink symbol or flexible symbol that does not overlap with SSB transmission, or the UE 115 may determine a slot is available for uplink transmission if it includes all uplink symbols or all flexible symbols, and none of the symbols of the slot overlap with SSB transmission.

For a given PDSCH, a UE 115 may report an associated HARQ-ACK bit in two or more PUCCH transmission occasions. The payload, or set of HARQ-ACK bits, reported in the two or more PUCCH transmission occasions may be overlapping but not the same. The wireless communications system 100 may implement techniques to provide a relationship between DAI values in the scheduling DCI messages and the location of HARQ-ACK bits in the multiple PUCCH transmission occasions. In some examples, these techniques may be applied for a Type-2 dynamic HARQ-ACK codebook.

In some examples, a DAI value in a DCI scheduling a PDSCH may determine a location of a HARQ-ACK bit corresponding to the PDSCH in a first, or earliest, PUCCH transmission occasion that includes the HARQ-ACK bit. In some examples, a DAI value in a DCI scheduling a PDSCH may determine a location of a HARQ-ACK bit corresponding to the PDSCH in a last, or Nth, PUCCH transmission occasion that includes the HARQ-ACK bit. In some examples, DCI scheduling a PDSCH may indicate multiple DAI values, where the nth DAI value of the DCI determine a location of the HARQ-ACK bit in the nth PUCCH transmission occasion used to report the HARQ-ACK bit. In some examples, for a PUCCH transmission occasion that carries a given HARQ-ACK bit, a difference between the DAI value of the scheduling DCI and a DAI value of the latest, previous DCI with HARQ-ACK that does not map to the PUCCH transmission occasion may determine the location of the HARQ-ACK bit in the PUCCH occasion. In some examples, at least some aspects from one or more of the above techniques for mapping DAI values to multiple PUCCH transmission occasions may be utilized together.

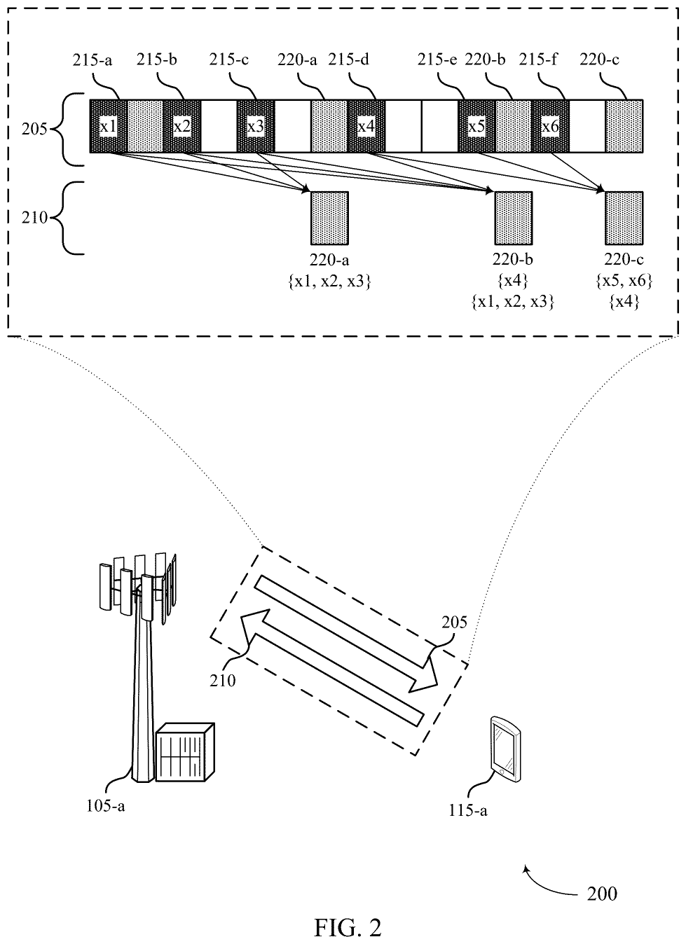

FIG. 2 shows an example of a wireless communications system 200 that supports dynamic codebook for mapping feedback to multiple slots in accordance with one or more aspects of the present disclosure. The wireless communications system 200 may implement aspects of the wireless communications system 100. For example, the wireless communications system 200 may include a UE 115-a and a network entity 105-a, which may be respective examples of a UE 115 and a network entity 105 described herein.

The UE 115-a may be configured with a downlink cell 205 and an uplink cell 210. The network entity 105-a may transmit downlink signaling, such as downlink shared channel signaling and downlink control channel signaling, to the UE 115-a via the downlink cell 205. The UE 115-a may transmit uplink signaling, such as uplink control channel signaling and uplink shared channel signaling, to the network entity 105-a via the uplink cell 210. The downlink cell 205 and the uplink cell 210 may be configured for TDD communications, where a slot is configured for downlink communications (e.g., a downlink slot 215) or uplink communications (e.g., an uplink slot 220).

The network entity 105-a may transmit downlink data information to the UE 115-a via a downlink shared channel during a downlink slot 215. For example, the network entity 105-a may transmit first downlink data information, including one or more HARQ-ACK bits (e.g., x₁), to the UE 115-a during a downlink slot 215-a. The UE 115-a may transmit feedback information for the first downlink data information during an uplink slot 220 via the uplink cell 210.

The wireless communications system 200 may support HARQ-ACK bit redundancy, where the UE 115-a reports a HARQ-ACK bit using two or more PUCCH transmission occasions. For example, the UE 115-a may report a HARQ-ACK bit N times across N different PUCCH transmission occasions, where N is two or more. Payloads reported in two different PUCCH transmission occasions may be overlapping, or including at least some common information or some common HARQ-ACK bits, but the payloads in the different PUCCH transmission occasions may not be identical.

For example, the UE 115-a may receive downlink data via PDSCH on the downlink cell 205 during the downlink slot 215-a, a downlink slot 215-b, and a downlink slot 215-c. The UE 115-a may transmit a first uplink control information message via PUCCH on the uplink cell 210 during an uplink slot 220-a. A first payload of the first uplink control information message may indicate HARQ-ACK feedback for the PDSCH received during the downlink slots 215. For example, the first payload may include a first HARQ-ACK bit (x₁) corresponding to the downlink slot 215-a, a second HARQ-ACK bit (x₂) corresponding to the downlink slot 215-b, and a third HARQ-ACK bit (x₃) corresponding to the downlink slot 215-c. That is, the first payload of a first PUCCH on the uplink slot 220-a may include HARQ-ACK bits {x₁, x₂, x₃}.

The UE 115-a may receive downlink data via PDSCH on the downlink cell during a downlink slot 215-d. The UE 115-a may transmit a second uplink control information message via PUCCH on the uplink cell 210 during an uplink slot 220-b. A second uplink payload of the second uplink control information message may include a fourth HARQ-ACK bit (x₄) corresponding to the downlink slot 215-c. The second uplink payload may also include at least a portion of the first uplink payload. For example, the second uplink payload may also include the first, second, and third HARQ-ACK bits (e.g., x₁, x₂, x₃). That is, the second payload of a second PUCCH on the uplink slot 220-b may include HARQ-ACK bits {x₁, x₂, x₃, x₄}, where HARQ-ACK bits x₁, x₂, \hat{ }x₃ are each transmitted twice, with a first transmission on the first PUCCH and a second transmission on the second PUCCH.

Similarly, the fourth HARQ-ACK bit may be transmitted twice, with a first transmission on the second PUCCH and a third transmission on a third PUCCH during an uplink slot 220-c. If the fourth HARQ-ACK bit corresponds to slot n, the fourth HARQ-ACK bit may be reported in slot n+4 and slot n+7 on the second PUCCH and the third PUCCH, respectively. The third PUCCH during the uplink slot 220-c may include first reports of a fifth HARQ-ACK bit (x₅) and a sixth HARQ-ACK bit (x₆) received via PDSCH during a downlink slot 215-e and a downlink slot 215-f, respectively. For example, the fourth HARQ-ACK bit may be common between a second payload of the second PUCCH and a third payload of the third PUCCH, while the other HARQ-ACK bits of the two payloads may be different.

A DCI scheduling a PDSCH may indicate a DAI value. With HARQ-ACK bit redundancy, a DAI value may correspond to a HARQ-ACK bit that is reported in multiple PUCCH transmission occasions in multiple HARQ-ACK payloads. The wireless communications system 200 may support a dynamic codebook for mapping a HARQ-ACK bit to multiple slots.

In some examples, a DAI value in a DCI scheduling a PDSCH may determine a location of a HARQ-ACK bit corresponding to the PDSCH in a first, or earliest, PUCCH transmission occasion that includes the HARQ-ACK bit. The location of the HARQ-ACK bit may be with respect to multiple HARQ-ACK bits that are reported in the same PUCCH transmission occasion that is the earliest PUCCH transmission occasion for reporting each of the multiple HARQ-ACK bits. The DAI value may be reset when the earliest PUCCH transmission for a HARQ-ACK bit changes compared to the previous HARQ-ACK bit. The same order may be kept in subsequent PUCCH transmission occasions among the HARQ-ACK bits with the same nth PUCCH transmission occasion.

For example, a first DCI received in the downlink slot 215-a scheduling a first PDSCH (x₁) may indicate a DAI value of ‘1’, a second DCI received in the downlink slot 215-b scheduling a second PDSCH (x₂) may indicate a DAI value of ‘2’, and a third DCI received in the downlink slot 215-c scheduling a third PDSCH (x₃) may indicate a DAI value of ‘3’. Based on the DAI, a HARQ-ACK feedback bit for x₁ may be in a first position in a first PUCCH transmission occasion during the uplink slot 220-a, x₂ may be in a second position, and x₃ may be in a third position. The HARQ-ACK feedback bits for x₁, x₂, and x₃ may have a consistent order in future PUCCH transmission occasions. For example, the order for x₁, x₂, and x₃ may be the same in a PUCCH transmitted during the uplink slot 220-b. In some examples, a DAI value in a DCI scheduling a PDSCH may determine a location of a HARQ-ACK bit corresponding to the PDSCH in a last, or Nth, PUCCH transmission occasion that includes the HARQ-ACK bit.

A fourth DCI received in the downlink slot 215-d scheduling a fourth PDSCH (x₄) may indicate a DAI value of ‘1’. For example, the DAI value has reset, as the earliest PUCCH transmission for a HARQ-ACK bit has changed compared to the previous HARQ-ACK bit. Or, the DAI values may have reset as HARQ-ACK for the fourth PDSCH is being reported for a first time, while the HARQ-ACK bits for the first through third PDSCHs are being reported for a second time. In some examples, the HARQ-ACK bit for the fourth PDSCH may be ordered before or after the HARQ-ACK bits for the first through third PDSCHs. For example, the HARQ-ACK payload may be {x₁, x₂, x₃, x₄} or {x₄, x₂, x₃, x₁}.

In some examples, DCI scheduling a PDSCH may indicate multiple DAI values. For example, an nth DAI value of the DCI determine a location of the HARQ-ACK bit in the nth PUCCH transmission occasion used to report the HARQ-ACK bit. The location or position may be with respect to all HARQ-ACK bits included in that PUCCH transmission occasion. For a PUCCH transmission occasion, if a HARQ-ACK bit for a PDSCH is to be included in a PUCCH as the nth transmission of the HARQ-ACK bit, the nth DAI value in the DCI that scheduled the PDSCH may determine a location or a position of the HARQ-ACK bit in the PUCCH, or HARQ-ACK payload of the PUCCH.

In some examples, for a PUCCH transmission occasion that carries a given HARQ-ACK bit, a difference between the DAI value of the scheduling DCI and a DAI value of the latest, previous DCI with HARQ-ACK that does not map to the PUCCH transmission occasion may determine the location of the HARQ-ACK bit in the PUCCH occasion. The location or position may be with respect to all HARQ-ACK bits included in that PUCCH transmission occasion.

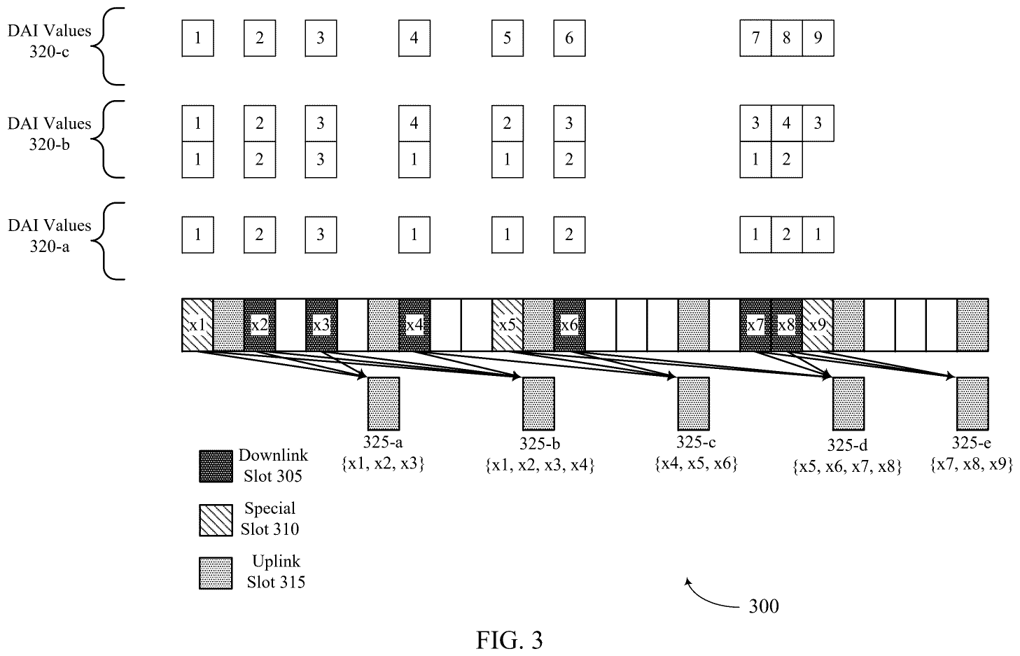

In some examples, at least some aspects from one or more of the above techniques for mapping DAI values to multiple PUCCH transmission occasions may be utilized together. Additional examples of DAI mapping techniques are described in more detail with reference to FIG. 3.

FIG. 3 shows an example of a DAI mapping scheme 300 that supports dynamic codebook for mapping feedback to multiple slots in accordance with one or more aspects of the present disclosure. The DAI mapping scheme 300 may implement aspects of the wireless communications system 100. For example, the DAI mapping scheme 300 may be implemented in a wireless communications system that supports HARQ-ACK bit redundancy.

A network entity may transmit downlink data information to a UE via a PDSCH during a downlink slot 305. For example, the network entity may transmit a first PDSCH, x₁, to the UE. The UE may transmit feedback information for the first downlink data information during uplink symbols of a special slot 310 or during an uplink slot 315. With HARQ-ACK bit redundancy, where the UE may report a HARQ-ACK feedback bit using two or more PUCCH transmission occasions. For example, the UE may report a HARQ-ACK bit N times across N different PUCCH transmission occasions, where N is two or more. Payloads reported in two different PUCCH transmission occasions may be overlapping, or including at least some common information or some common HARQ-ACK bits, but the payloads in the different PUCCH transmission occasions may not be identical.

A DCI scheduling a PDSCH may indicate a DAI value. With HARQ-ACK bit redundancy, a DAI value may correspond to a HARQ-ACK bit that is reported in multiple PUCCH transmission occasions in multiple HARQ-ACK payloads. The DAI mapping scheme 300 show three different examples for constructing a HARQ-ACK codebook in multiple PUCCH occasions based on DAI indicated by a DCI.

A first set of DAI values 320-a may correspond to an example where a first DAI value in DCI determines a location of a corresponding HARQ-ACK bit in an earliest PUCCH transmission occasion. For example, a DAI value in a DCI scheduling a PDSCH may determine a location of a HARQ-ACK bit corresponding to the PDSCH in a first, or earliest, PUCCH transmission occasion that includes the HARQ-ACK bit. The location of the HARQ-ACK bit may be with respect to multiple HARQ-ACK bits that are reported in the same PUCCH transmission occasion that is the earliest PUCCH transmission occasion for reporting each of the multiple HARQ-ACK bits. The DAI value may be reset when the earliest PUCCH transmission for a HARQ-ACK bit changes compared to the previous HARQ-ACK bit. The same order may be kept in subsequent PUCCH transmission occasions among the HARQ-ACK bits with the same nth PUCCH transmission occasion.

For the first set of DAI values 320-a, a first DCI scheduling a first PDSCH (x₁) may indicate a DAI value of ‘1’, a second DCI scheduling a second PDSCH (x₂) may indicate a DAI value of ‘2’, and a third DCI scheduling a third PDSCH (x₃) may indicate a DAI value of ‘3’. Based on the DAI, a HARQ-ACK feedback bit for x₁ may be in a first position in a first PUCCH 325-a, x₂ may be in a second position in the first PUCCH 325-a, and x₃ may be in a third position in the first PUCCH 325-a.

For the first set of DAI values 320-a, the HARQ-ACK feedback bits for x₁, x₂, and x₃ may have a consistent order in future PUCCH transmission occasions. For example, the order for x₁, x₂, and x₃ may be the same in a second PUCCH 325-b.

In some examples, a DAI value in a DCI scheduling a PDSCH may determine a location of a HARQ-ACK bit corresponding to the PDSCH in a last, or N th, PUCCH transmission occasion that includes the HARQ-ACK bit. Type-2 codebook construction may be at the sub-codebook level for the first set of DAI values 320-a. A sub-codebook may be constructed based on the DAI values of scheduling DCI for reporting in the first, or earliest, PUCCH transmission occasion. In a given PUCCH transmission occasion, the UE may transmit multiple sub-codebooks. An original sub-codebook, constructed based on DAI, may include HARQ-ACK bits that are being reported for a first time. A second sub-codebook may be a copy of the original and include HARQ-ACK bits that are being reported not for the first time but with the same first time (that is not the present PUCCH transmission occasion). For example, the second sub-codebook may correspond to HARQ-ACK bits that are being reported for a second time or were reported for a first time in the previous PUCCH transmission occasion. A third sub-codebook may correspond to HARQ-ACK bits that are being reported for a third time, and so on.

A fourth DCI scheduling a fourth PDSCH (x₄) may indicate a DAI value of ‘1’. For example, the DAI value has reset, as the earliest PUCCH transmission for a HARQ-ACK bit has changed compared to the previous HARQ-ACK bit. Or, the DAI values may have reset as HARQ-ACK for the fourth PDSCH is being reported for a first time, while the HARQ-ACK bits for the first through third PDSCHs are being reported for a second time. In some examples, the HARQ-ACK bit for the fourth PDSCH may be ordered before or after the HARQ-ACK bits for the first through third PDSCHs. For example, the HARQ-ACK payload may be {x₁, x₂, x₃, x₄} or {x₄, x₂, x₃, x₁}. Similarly, DCI scheduling PDSCH carrying x₅ and DCI scheduling PDSCH carrying x₆ may indicate a DAI value of ‘1’ and a ‘2’, respectively, indicating a location in the codebook with respect to these two ACK or NACK bits (that are being reported for the first time). HARQ-ACK bits for these PDSCH may each be reported for a first time via a third PUCCH 325-c, and the DAI values may reset with the DCI that schedules the PDSCH x₅.

In some examples, DCI scheduling a PDSCH may indicate multiple DAI values. For example, DCI indicating a second set of DAI values 320-b may each include two DAI values. For example, an nth DAI value of the DCI determine a location of the HARQ-ACK bit in the nth PUCCH transmission occasion used to report the HARQ-ACK bit. The location or position may be with respect to all HARQ-ACK bits included in that PUCCH transmission occasion. For a PUCCH transmission occasion, if a HARQ-ACK bit for a PDSCH is to be included in a PUCCH as the nth transmission of the HARQ-ACK bit, the nth DAI value in the DCI that scheduled the PDSCH may determine a location or a position of the HARQ-ACK bit in the PUCCH, or HARQ-ACK payload of the PUCCH.

For example, DCI scheduling x₁ may include two DAI values. The first DAI value may correspond to a position of a HARQ-ACK feedback bit for x₁ in the first PUCCH 325-a, and the second DAI value may correspond to a position of the HARQ-ACK feedback bit for x₁ in the second PUCCH 325-b. For example, the HARQ-ACK feedback bit for x₁ may be in first position of the HARQ-ACK payload transmitted on the first PUCCH 325-a and the second PUCCH 325-b. Downlink control information scheduling x₄ may include DAI values. The first DAI value, ‘4’, may indicate a position of the HARQ-ACK feedback bit for x₄ in the second PUCCH 325-b, and the second DAI value, ‘1’, may indicate a position of the HARQ-ACK feedback bit for x₄ in the third PUCCH 325-c. For example, the HARQ-ACK bit for x₄ may be in a fourth position of the HARQ-ACK payload where x₄ is being reported for a first time (e.g., on the second PUCCH 325-b), and the HARQ-ACK bit for x₄ may be in a first position of the HARQ-ACK payload where x₄ is being reported for a second time (e.g., on the third PUCCH 325-c).

In some examples corresponding to the second set of DAI values 320-b, a DCI may indicate a single DAI value, such as if the HARQ-ACK bit is only reported once. For example, a HARQ-ACK bit for PDSCH x₉ may be reported once via a fifth PUCCH 325-e. For example, the PDSCH x₉ may be received in a slot before a fourth PUCCH 325-d, such that a processing timeline for PDSCH x₉ cannot be satisfied in order to transmit the HARQ-ACK bit for x₉ via the fourth PUCCH 325-d. Downlink control information that schedules the PDSCH x₉ may indicate a single DAI value for the fifth PUCCH 325-e. In some examples, the UE may report the HARQ-ACK bit for the PDSCH x₉ in another PUCCH transmission occasion not shown, separately or with other HARQ-ACK feedback bits.

In some examples, such as for a third set of DAI values 320-c, a position of a HARQ-ACK bit for a PDSCH in a PUCCH may be based on a difference between a DAI of the scheduling DCI and a DAI value of a latest DCI that does not map to the PUCCH. For example, for a PUCCH transmission occasion that carries a given HARQ-ACK bit, a difference between the DAI value of the scheduling DCI and a DAI value of the latest, previous DCI with HARQ-ACK that does not map to the PUCCH transmission occasion may determine the location of the HARQ-ACK bit in the PUCCH occasion. The location or position may be with respect to all HARQ-ACK bits included in that PUCCH transmission occasion.

For the third set of DAI values 320-c, the latest, previous DCI may be based on monitoring occasion or associated component carrier index. The latest, previous DCI may be considered when it is within the same DAI counting process and not before a reset of the DAI value. Otherwise, the latest, previous DCI may not be considered. For example, for the first PUCCH 325-a and the second PUCCH 325-b, only the DAI of the scheduling DCI determines the location of the HARQ-ACK feedback bits for x₁, x₂, x₃, and x₄.

For example, DCI scheduling PDSCH x₅ may indicate a DAI value for ‘5’ (or DAI value of 1 after modulo 4 operation given the 2-bits of the DAI field). For the third PUCCH 325-c, the HARQ-ACK bit for x₅ may be in a second position, as DCI scheduling PDSCH x₃ may be a most recently-received DCI which does not have a HARQ-ACK bit reported in the third PUCCH 325-c. The DCI scheduling the PDSCH x₃ may have indicated a DAI value of ‘3’, so a difference between ‘5’ and ‘3’ may correspond to the HARQ-ACK bit for x₅ being in a second position of the third PUCCH 325-c. For the fourth PUCCH 325-d, the PDSCH x₄ may be a most recently non-included HARQ-ACK bit. Downlink control information scheduling the PDSCH x₄ may have indicated a DAI value of ‘4’, so the HARQ-ACK bit for x₅ in the fourth PUCCH 325-d may correspond to a difference between ‘5’ and ‘4’, such that the HARQ-ACK bit for x₅ is in the first position of the fourth PUCCH 325-d.

For the third set of DAI values 320-c, the DAI value may be reset when it is a first, earliest DCI with a HARQ-ACK bit mapped to a PUCCH transmission occasion as the first PUCCH transmission occasions (e.g., among two or more PUCCH transmission occasions that include the HARQ-ACK bit). In the example for the third set of DAI values 320-c, DAI may be reset with a first DCI that schedules x₁, but the DAI counting process may be contiguous through DCI scheduling PDSCH x₉.

In some examples, aspects of one or more of the techniques corresponding to the first set of DAI values 320-a, the second set of DAI values 320-b, and the third set of DAI values 320-c, or any combination thereof, may be utilized together. For example, a DAI value in DCI may determine a location of a corresponding HARQ-ACK bit in a first, earliest PUCCH transmission occasion among two or more PUCCH transmission occasions that include the HARQ-ACK bit, similar to the first set of DAI values 320-a. The location may be with respect to all HARQ-ACK bits included in that PUCCH transmission occasion, and not just with respect to HARQ-ACK bits that are being reported for the first time, similar to the third set of DAI values 320-c. In this example, HARQ-ACK reporting may not be based on sub-codebooks. In some examples, HARQ-ACK bits that are not being reported for the first time may be ordered based on an order of received DCI (for example, DAI value may not play a role for the location of the HARQ-ACK bits that are being reported after the first time). This example may correspond to indicating only the first DAI value of each DCI in the second set of DAI values 320-b.

In some examples, HARQ-ACK bits for PDSCH may be transmitted in different orders than shown. For example, a HARQ-ACK bit for x₃ may be reported via the first PUCCH 325-a and the third PUCCH 325-c instead of the second PUCCH 325-b. In some examples, DCI scheduling PDSCH x₃ may indicate a DAI value that corresponds to transmitting the HARQ-ACK bit for x₃ via the third PUCCH 325-c.

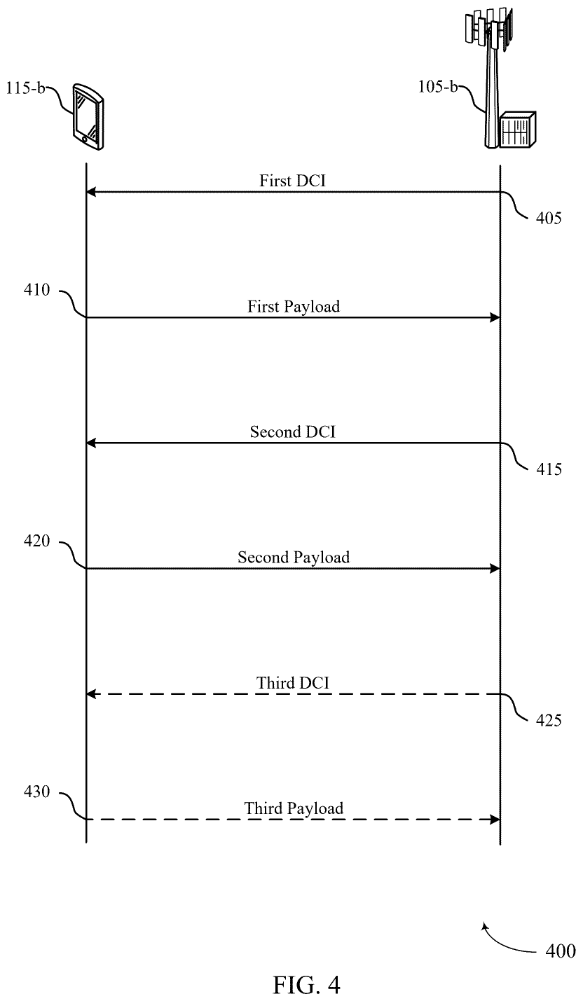

FIG. 4 shows an example of a process flow 400 that supports dynamic codebook for mapping feedback to multiple slots in accordance with one or more aspects of the present disclosure. The process flow 400 includes a UE 115-b and a network entity 105-b, which may be examples of the corresponding devices as described with respect to FIG. 1-3. In the following description of the process flow 400, the operations between the UE 115-b and the network entity 105-b may be performed in a different order than the example order shown. Some operations may also be omitted from the process flow 400, and other operations may be added to the process flow 400. Further, although some operations or signaling may be shown to occur at different times for discussion purposes, these operations may actually occur at the same time.

At 405, the UE 115-b may receive a first DCI that schedules a first downlink shared channel transmission. The first DCI may indicate a first DAI value for first feedback information associated with the first downlink shared channel transmission. In some cases, the first DAI value may indicate a first location of the first feedback information within the first uplink channel transmission occasion.

At 410, the UE 115-b may transmit the first DAI value during a first uplink channel transmission occasion and based on the first DAI value. The first payload may include the first feedback information associated with the first downlink shared channel transmission at a first location of a first codebook.

At 415, the UE 115-b may receive a second DCI that schedules a second downlink shared channel transmission. The second DCI may indicate a second DAI value for second feedback information associated with the second downlink shared channel transmission. In some cases, the second DAI value may indicate a second location of the second feedback information within the second uplink channel transmission occasion.

At 420, the UE 115-b may transmit a second payload during a second uplink channel transmission occasion and based on the first DAI value and the second DAI value. The second payload may include the first feedback information at a second location of a second codebook and the second feedback information at a third location of a third codebook. The second payload may include the second codebook concatenated with the third codebook. In some examples, the second payload may include the second feedback information concatenated to an end of the first feedback information. In some cases, the second payload may include the second feedback information concatenated to a beginning of the first feedback information. Additionally, or alternatively, the second payload may include the second codebook and the third codebook. The second codebook may include a second report of the first feedback information (e.g., a second instance of the first feedback information, or a second time that the first feedback information is reported). The third codebook may include a first report of the second feedback information (e.g., a first instance of the second feedback information, or a first time that the second feedback information is reported).

In some implementations, the first DAI value may indicate a location of the first feedback information within the second uplink channel transmission occasion. In some cases, the first DCI may indicate a set of DAI values that includes the first DAI value and a third DAI value. The third DAI value may be associated with the second uplink channel transmission occasion. In some cases, the second DAI value may correspond to a location of the second feedback information within a subset of feedback bits of the second payload. In some implementations, the second DAI value may correspond to a location of the second feedback information within all feedback bits of the second payload. An ordering of the first feedback information within the first uplink channel transmission occasion may be based on a timing of a set of DCI that schedules a downlink shared channel transmission. The set of DCI may include the first DCI that schedules the first downlink shared channel transmission.

At 425, the UE 115-b may receive a third DCI that schedules a third downlink shared channel transmission. The third DCI may indicate a third DAI value for third feedback information associated with the third downlink shared channel transmission.

At 430, the UE 115-b may transmit a third payload during a third uplink channel transmission occasion. The third payload may include the second feedback information at a fourth location of a fourth codebook and the third feedback information at a fifth location of a fifth codebook based on the second DAI value and the third DAI value. The third payload may include the fourth codebook concatenated with the fifth codebook. In some cases, a location of the third feedback information within the third uplink channel transmission occasion may be based on a difference between the third DAI value and a highest DAI value among a set of DAI values associated with the first payload.

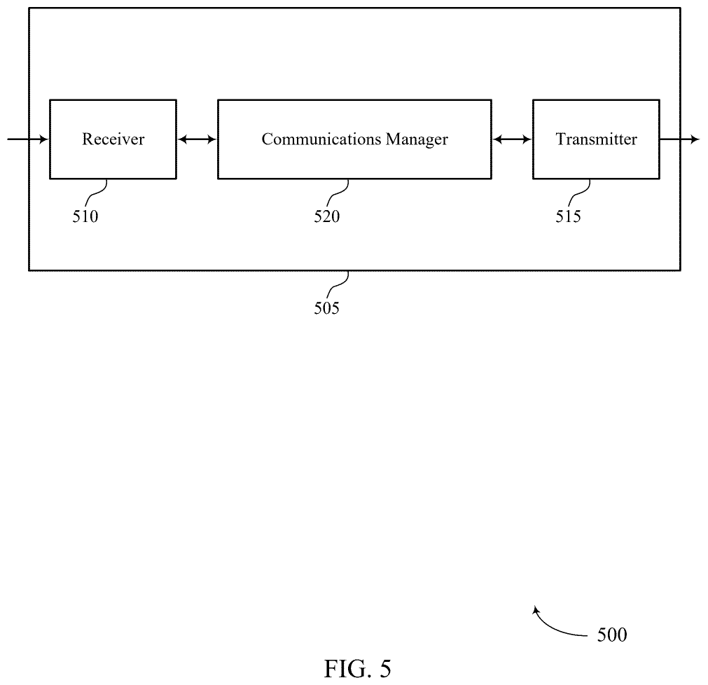

FIG. 5 shows a block diagram 500 of a device 505 that supports dynamic codebook for mapping feedback to multiple slots in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques.

Each of these components may be in communication with one another (e.g., via one or more buses).

The receiver 510 may provide a means for receiving information such as packets, user data, control information, or any combination thereof associated with various information channels (e.g., control channels, data channels, information channels related to dynamic codebook for mapping feedback to multiple slots). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to dynamic codebook for mapping feedback to multiple slots). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of dynamic codebook for mapping feedback to multiple slots as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communication in accordance with examples as disclosed herein. For example, the communications manager 520 is capable of, configured to, or operable to support a means for receiving a first DCI that schedules a first downlink shared channel transmission, where the first DCI indicates a first DAI value for first feedback information associated with the first downlink shared channel transmission. The communications manager 520 is capable of, configured to, or operable to support a means for transmitting, during a first uplink channel transmission occasion and based on the first DAI value, a first payload that includes the first feedback information associated with the first downlink shared channel transmission at a first location of a first codebook. The communications manager 520 is capable of, configured to, or operable to support a means for receiving a second DCI that schedules a second downlink shared channel transmission, where the second DCI indicates a second DAI value for second feedback information associated with the second downlink shared channel transmission. The communications manager 520 is capable of, configured to, or operable to support a means for transmitting, during a second uplink channel transmission occasion and based on the first DAI value and the second DAI value, a second payload that includes the first feedback information at a second location of a second codebook and the second feedback information at a third location of a third codebook, where the second payload includes the second codebook concatenated with the third codebook.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for dynamic codebook for mapping feedback to multiple slots, which may result in reduced processing, reduced power consumption, reduced restrictions for uplink channel transmission, and more efficient utilization of communication resources, among other advantages.

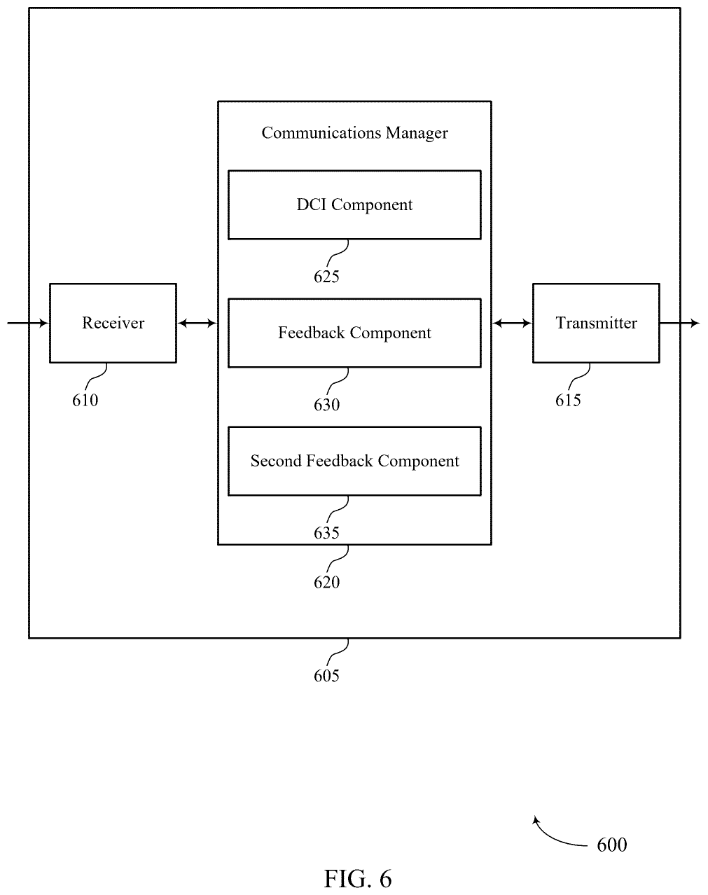

FIG. 6 shows a block diagram 600 of a device 605 that supports dynamic codebook for mapping feedback to multiple slots in accordance with one or more aspects of the present disclosure. The device 605 may be an example of aspects of a device 505 or a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to dynamic codebook for mapping feedback to multiple slots). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to dynamic codebook for mapping feedback to multiple slots). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of dynamic codebook for mapping feedback to multiple slots as described herein. For example, the communications manager 620 may include a DCI component 625, a feedback component 630, a second feedback component 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication in accordance with examples as disclosed herein. The DCI component 625 is capable of, configured to, or operable to support a means for receiving a first DCI that schedules a first downlink shared channel transmission, where the first DCI indicates a first DAI value for first feedback information associated with the first downlink shared channel transmission. The feedback component 630 is capable of, configured to, or operable to support a means for transmitting, during a first uplink channel transmission occasion and based on the first DAI value, a first payload that includes the first feedback information associated with the first downlink shared channel transmission at a first location of a first codebook. The DCI component 625 is capable of, configured to, or operable to support a means for receiving a second DCI that schedules a second downlink shared channel transmission, where the second DCI indicates a second DAI value for second feedback information associated with the second downlink shared channel transmission. The second feedback component 635 is capable of, configured to, or operable to support a means for transmitting, during a second uplink channel transmission occasion and based on the first DAI value and the second DAI value, a second payload that includes the first feedback information at a second location of a second codebook and the second feedback information at a third location of a third codebook, where the second payload includes the second codebook concatenated with the third codebook.

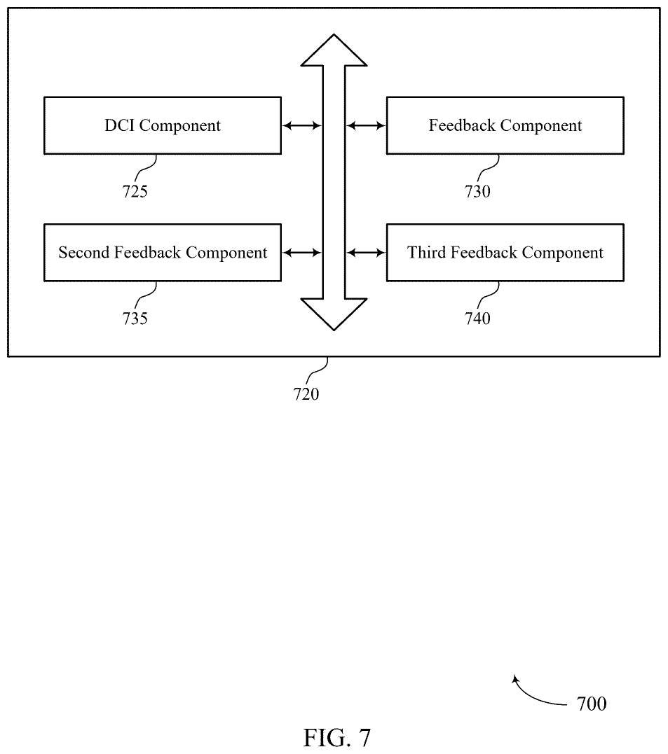

FIG. 7 shows a block diagram 700 of a communications manager 720 that supports dynamic codebook for mapping feedback to multiple slots in accordance with one or more aspects of the present disclosure. The communications manager 720 may be an example of aspects of a communications manager 520, a communications manager 620, or both, as described herein. The communications manager 720, or various components thereof, may be an example of means for performing various aspects of dynamic codebook for mapping feedback to multiple slots as described herein. For example, the communications manager 720 may include a DCI component 725, a feedback component 730, a second feedback component 735, a third feedback component 740, or any combination thereof. Each of these components, or components or subcomponents thereof (e.g., one or more processors, one or more memories), may communicate, directly or indirectly, with one another (e.g., via one or more buses).

The communications manager 720 may support wireless communication in accordance with examples as disclosed herein. The DCI component 725 is capable of, configured to, or operable to support a means for receiving a first DCI that schedules a first downlink shared channel transmission, where the first DCI indicates a first DAI value for first feedback information associated with the first downlink shared channel transmission. The feedback component 730 is capable of, configured to, or operable to support a means for transmitting, during a first uplink channel transmission occasion and based on the first DAI value, a first payload that includes the first feedback information associated with the first downlink shared channel transmission at a first location of a first codebook. In some examples, the DCI component 725 is capable of, configured to, or operable to support a means for receiving a second DCI that schedules a second downlink shared channel transmission, where the second DCI indicates a second DAI value for second feedback information associated with the second downlink shared channel transmission. The second feedback component 735 is capable of, configured to, or operable to support a means for transmitting, during a second uplink channel transmission occasion and based on the first DAI value and the second DAI value, a second payload that includes the first feedback information at a second location of a second codebook and the second feedback information at a third location of a third codebook, where the second payload includes the second codebook concatenated with the third codebook.

In some examples, the first DAI value indicates a first location of the first feedback information within the first uplink channel transmission occasion. In some examples, the second DAI value indicates a second location of the second feedback information within the second uplink channel transmission occasion.

In some examples, the first DAI value indicates a location of the first feedback information within the second uplink channel transmission occasion.

In some examples, the second payload includes the second feedback information concatenated to an end of the first feedback information.

In some examples, the second payload includes the second feedback information concatenated to a beginning of the first feedback information.

In some examples, the second payload includes the second codebook that includes a second report of the first feedback information and the third codebook that includes a first report of the second feedback information.

In some examples, the first DCI indicates a set of DAI values including the first DAI value and a third DAI value. In some examples, the third DAI value is associated with the second uplink channel transmission occasion.

In some examples, the DCI component 725 is capable of, configured to, or operable to support a means for receiving a third DCI that schedules a third downlink shared channel transmission, where the third DCI indicates a third DAI value for third feedback information associated with the third downlink shared channel transmission. In some examples, the third feedback component 740 is capable of, configured to, or operable to support a means for transmitting, during a third uplink channel transmission occasion, a third payload that includes the second feedback information at a fourth location of a fourth codebook and the third feedback information at a fifth location of a fifth codebook based on the second DAI value and the third DAI value, where the third payload includes the fourth codebook concatenated with the fifth codebook.

In some examples, a location of the third feedback information within the third uplink channel transmission occasion is based on a difference between the third DAI value and a highest DAI value among a set of DAI values associated with the first payload.

In some examples, the second DAI value corresponds to a location of the second feedback information within a subset of feedback bits of the second payload.

In some examples, the second DAI value corresponds to a location of the second feedback information within all feedback bits of the second payload.

In some examples, an ordering of the first feedback information within the first uplink channel transmission occasion is based on a timing of a set of DCI that schedules a downlink shared channel transmission, including the first DCI that schedules the first downlink shared channel transmission.

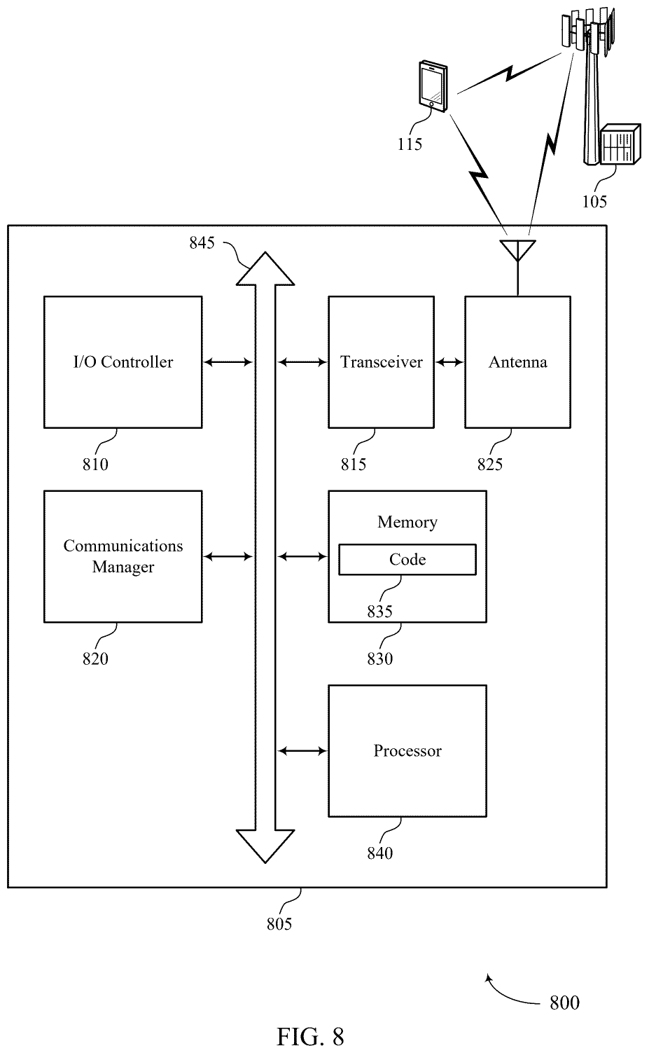

FIG. 8 shows a diagram of a system 800 including a device 805 that supports dynamic codebook for mapping feedback to multiple slots in accordance with one or more aspects of the present disclosure. The device 805 may be an example of or include components of a device 505, a device 605, or a UE 115 as described herein. The device 805 may communicate (e.g., wirelessly) with one or more other devices (e.g., network entities 105, UEs 115, or a combination thereof). The device 805 may include components for bi-directional voice and data communications including components for transmitting and receiving communications, such as a communications manager 820, an input/output (I/O) controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a basic I/O system (BIOS) which may control basic hardware or software operation such as the interaction with peripheral components or devices.

The at least one processor 840 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting dynamic codebook for mapping feedback to multiple slots). For example, the device 805 or a component of the device 805 may include at least one processor 840 and at least one memory 830 coupled with or to the at least one processor 840, the at least one processor 840 and the at least one memory 830 configured to perform various functions described herein.

In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

The communications manager 820 may support wireless communication in accordance with examples as disclosed herein. For example, the communications manager 820 is capable of, configured to, or operable to support a means for receiving a first DCI that schedules a first downlink shared channel transmission, where the first DCI indicates a first DAI value for first feedback information associated with the first downlink shared channel transmission. The communications manager 820 is capable of, configured to, or operable to support a means for transmitting, during a first uplink channel transmission occasion and based on the first DAI value, a first payload that includes the first feedback information associated with the first downlink shared channel transmission at a first location of a first codebook. The communications manager 820 is capable of, configured to, or operable to support a means for receiving a second DCI that schedules a second downlink shared channel transmission, where the second DCI indicates a second DAI value for second feedback information associated with the second downlink shared channel transmission. The communications manager 820 is capable of, configured to, or operable to support a means for transmitting, during a second uplink channel transmission occasion and based on the first DAI value and the second DAI value, a second payload that includes the first feedback information at a second location of a second codebook and the second feedback information at a third location of a third codebook, where the second payload includes the second codebook concatenated with the third codebook.

By including or configuring the communications manager 820 in accordance with examples as described herein, the device 805 may support techniques for dynamic codebook for mapping feedback to multiple slots, which may result in improved communication reliability, reduced latency, improved user experience related to reduced processing, reduced power consumption, reduced restrictions for uplink channel transmission, improved coordination between devices, improved utilization of processing capability and more efficient utilization of communication resources, among other advantages.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of dynamic codebook for mapping feedback to multiple slots as described herein, or the at least one processor 840 and the at least one memory 830 may be otherwise configured to, individually or collectively, perform or support such operations.

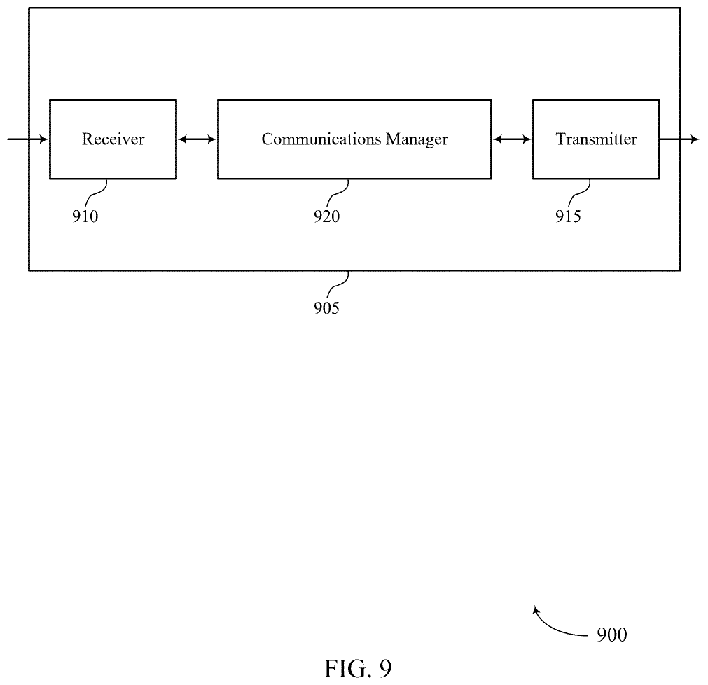

FIG. 9 shows a block diagram 900 of a device 905 that supports dynamic codebook for mapping feedback to multiple slots in accordance with one or more aspects of the present disclosure. The device 905 may be an example of aspects of a network entity 105 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to, individually or collectively, support or enable the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations or components thereof may be examples of means for performing various aspects of dynamic codebook for mapping feedback to multiple slots as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor (e.g., referred to as a processor-executable code). If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication in accordance with examples as disclosed herein. For example, the communications manager 920 is capable of, configured to, or operable to support a means for outputting a first DCI that schedules a first downlink shared channel transmission, where the first DCI indicates a first DAI value for first feedback information associated with the first downlink shared channel transmission. The communications manager 920 is capable of, configured to, or operable to support a means for obtaining, during a first uplink channel transmission occasion and based on the first DAI value, a first payload that includes the first feedback information for the first downlink shared channel transmission at a first location of a first codebook. The communications manager 920 is capable of, configured to, or operable to support a means for outputting a second DCI that schedules a second downlink shared channel transmission, where the second DCI indicates a second DAI value for second feedback information associated with the second downlink shared channel transmission. The communications manager 920 is capable of, configured to, or operable to support a means for obtaining, during a second uplink channel transmission occasion and based on the first DAI value and the second DAI value, a second payload that includes the first feedback information at a second location of a second codebook and the second feedback information at a third location of a third codebook, where the second payload includes the second codebook concatenated with the third codebook.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for dynamic codebook for mapping feedback to multiple slots, which may result in reduced processing, reduced power consumption, reduced restrictions for uplink channel transmission, and more efficient utilization of communication resources, among other advantages.

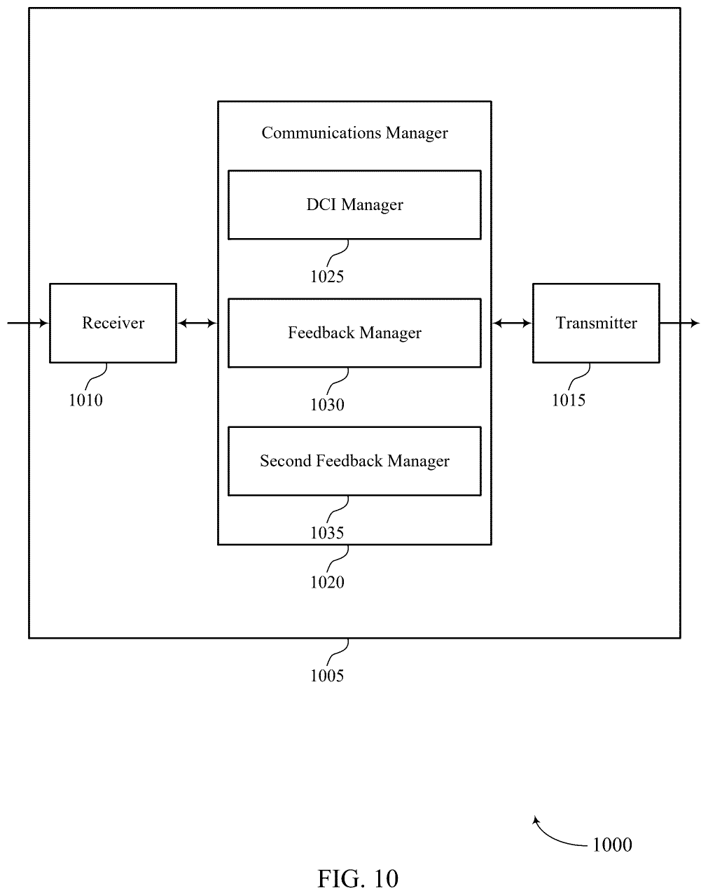

FIG. 10 shows a block diagram 1000 of a device 1005 that supports dynamic codebook for mapping feedback to multiple slots in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to support the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of dynamic codebook for mapping feedback to multiple slots as described herein. For example, the communications manager 1020 may include a DCI manager 1025, a feedback manager 1030, a second feedback manager 1035, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication in accordance with examples as disclosed herein. The DCI manager 1025 is capable of, configured to, or operable to support a means for outputting a first DCI that schedules a first downlink shared channel transmission, where the first DCI indicates a first DAI value for first feedback information associated with the first downlink shared channel transmission. The feedback manager 1030 is capable of, configured to, or operable to support a means for obtaining, during a first uplink channel transmission occasion and based on the first DAI value, a first payload that includes the first feedback information for the first downlink shared channel transmission at a first location of a first codebook. The DCI manager 1025 is capable of, configured to, or operable to support a means for outputting a second DCI that schedules a second downlink shared channel transmission, where the second DCI indicates a second DAI value for second feedback information associated with the second downlink shared channel transmission. The second feedback manager 1035 is capable of, configured to, or operable to support a means for obtaining, during a second uplink channel transmission occasion and based on the first DAI value and the second DAI value, a second payload that includes the first feedback information at a second location of a second codebook and the second feedback information at a third location of a third codebook, where the second payload includes the second codebook concatenated with the third codebook.

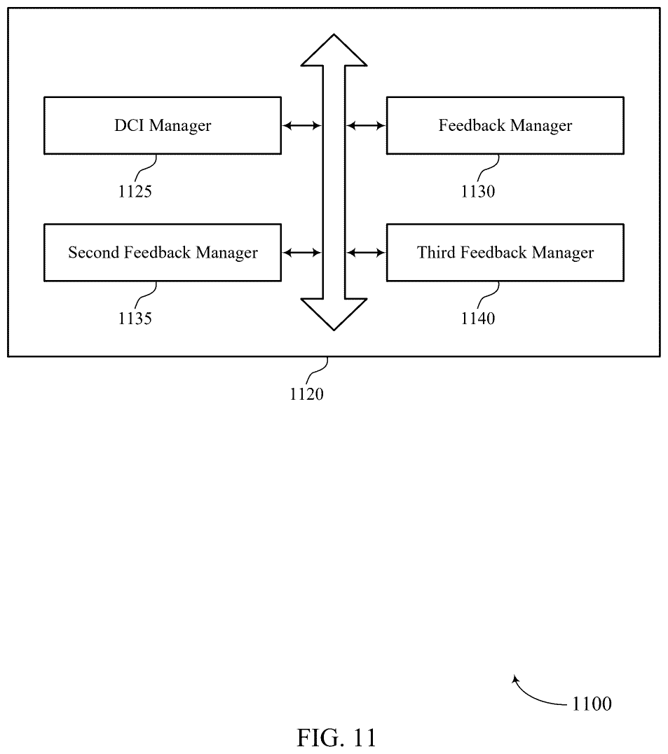

FIG. 11 shows a block diagram 1100 of a communications manager 1120 that supports dynamic codebook for mapping feedback to multiple slots in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of dynamic codebook for mapping feedback to multiple slots as described herein. For example, the communications manager 1120 may include a DCI manager 1125, a feedback manager 1130, a second feedback manager 1135, a third feedback manager 1140, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communication in accordance with examples as disclosed herein. The DCI manager 1125 is capable of, configured to, or operable to support a means for outputting a first DCI that schedules a first downlink shared channel transmission, where the first DCI indicates a first DAI value for first feedback information associated with the first downlink shared channel transmission. The feedback manager 1130 is capable of, configured to, or operable to support a means for obtaining, during a first uplink channel transmission occasion and based on the first DAI value, a first payload that includes the first feedback information for the first downlink shared channel transmission at a first location of a first codebook. In some examples, the DCI manager 1125 is capable of, configured to, or operable to support a means for outputting a second DCI that schedules a second downlink shared channel transmission, where the second DCI indicates a second DAI value for second feedback information associated with the second downlink shared channel transmission. The second feedback manager 1135 is capable of, configured to, or operable to support a means for obtaining, during a second uplink channel transmission occasion and based on the first DAI value and the second DAI value, a second payload that includes the first feedback information at a second location of a second codebook and the second feedback information at a third location of a third codebook, where the second payload includes the second codebook concatenated with the third codebook.

In some examples, the first DAI value indicates a first location of the first feedback information within the first uplink channel transmission occasion. In some examples, the second DAI value indicates a second location of the second feedback information within the second uplink channel transmission occasion.

In some examples, the first DAI value indicates a location of the first feedback information within the second uplink channel transmission occasion.

In some examples, the second payload includes the second feedback information concatenated to an end of the first feedback information.

In some examples, the second payload includes the second feedback information concatenated to a beginning of the first feedback information.

In some examples, the second payload includes the second codebook that includes a second report of the first feedback information and the third codebook that includes a first report of the second feedback information.

In some examples, the first DCI indicates a set of DAI values including the first DAI value and a third DAI value. In some examples, the third DAI value is associated with the second uplink channel transmission occasion.

In some examples, the DCI manager 1125 is capable of, configured to, or operable to support a means for outputting a third DCI that schedules a third downlink shared channel transmission, where the third DCI indicates a third DAI value for third feedback information associated with the third downlink shared channel transmission. In some examples, the third feedback manager 1140 is capable of, configured to, or operable to support a means for obtaining, during a third uplink channel transmission occasion, a third payload that includes the second feedback information at a fourth location of a fourth codebook and the third feedback information at a fifth location of a fifth codebook based on the second DAI value and the third DAI value, where the third payload includes the fourth codebook concatenated with the fifth codebook.

In some examples, a location of the third feedback information within the third uplink channel transmission occasion is based on a difference between the third DAI value and a highest DAI value among a set of DAI values associated with the first payload.

In some examples, the second DAI value corresponds to a location of the second feedback information within a subset of feedback bits of the second payload.

In some examples, the second DAI value corresponds to a location of the second feedback information within all feedback bits of the second payload.

In some examples, an ordering of the first feedback information within the first uplink channel transmission occasion is based on a timing of a set of DCI that schedules a downlink shared channel transmission, including the first DCI that schedules the first downlink shared channel transmission.

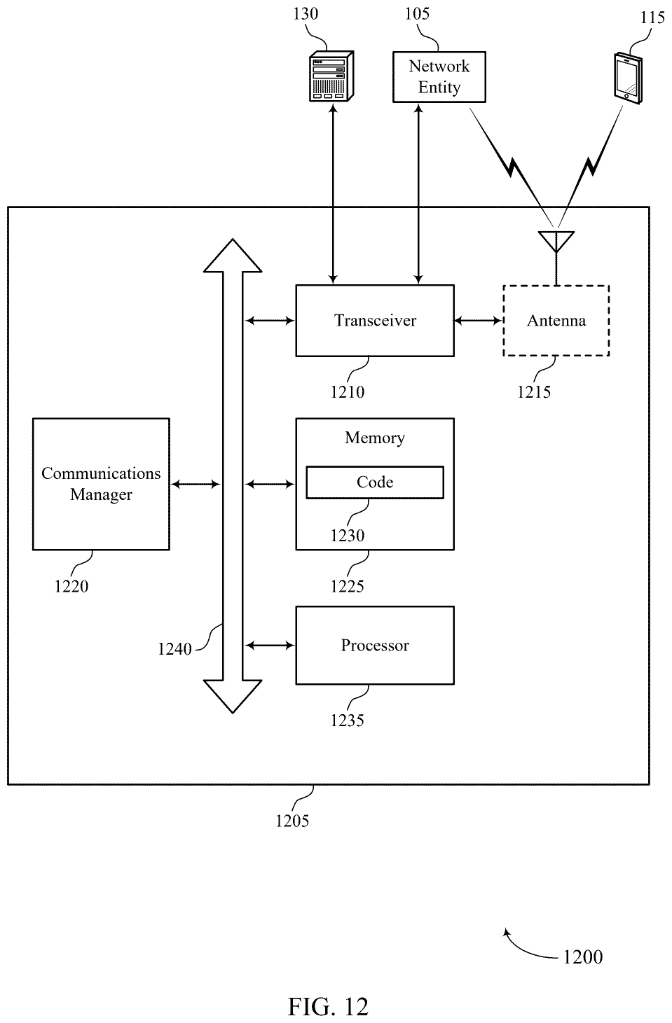

FIG. 12 shows a diagram of a system 1200 including a device 1205 that supports dynamic codebook for mapping feedback to multiple slots in accordance with one or more aspects of the present disclosure. The device 1205 may be an example of or include components of a device 905, a device 1005, or a network entity 105 as described herein. The device 1205 may communicate with other network devices or network equipment such as one or more of the network entities 105, UEs 115, or any combination thereof. The communications may include communications over one or more wired interfaces, over one or more wireless interfaces, or any combination thereof. The device 1205 may include components that support outputting and obtaining communications, such as a communications manager 1220, a transceiver 1210, one or more antennas 1215, at least one memory 1225, code 1230, and at least one processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or one or more memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or one or more memory components (e.g., the at least one processor 1235, the at least one memory 1225, or both), may be included in a chip or chip assembly that is installed in the device 1205. In some examples, the transceiver 1210 may be operable to support communications via one or more communications links (e.g., communication link(s) 125, backhaul communication link(s) 120, a midhaul communication link 162, a fronthaul communication link 168).

The at least one memory 1225 may include RAM, ROM, or any combination thereof. The at least one memory 1225 may store computer-readable, computer-executable, or processor-executable code, such as the code 1230. The code 1230 may include instructions that, when executed by one or more of the at least one processor 1235, cause the device 1205 to perform various functions described herein. The code 1230 may be stored in a non-transitory computer-readable medium such as system memory or another type of memory. In some cases, the code 1230 may not be directly executable by a processor of the at least one processor 1235 but may cause a computer (e.g., when compiled and executed) to perform functions described herein. In some cases, the at least one memory 1225 may include, among other things, a BIOS which may control basic hardware or software operation such as the interaction with peripheral components or devices. In some examples, the at least one processor 1235 may include multiple processors and the at least one memory 1225 may include multiple memories. One or more of the multiple processors may be coupled with one or more of the multiple memories which may, individually or collectively, be configured to perform various functions herein (for example, as part of a processing system).

The at least one processor 1235 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1235 may be configured to operate a memory array using a memory controller. In some other cases, a memory controller may be integrated into one or more of the at least one processor 1235. The at least one processor 1235 may be configured to execute computer-readable instructions stored in a memory (e.g., one or more of the at least one memory 1225) to cause the device 1205 to perform various functions (e.g., functions or tasks supporting dynamic codebook for mapping feedback to multiple slots). For example, the device 1205 or a component of the device 1205 may include at least one processor 1235 and at least one memory 1225 coupled with one or more of the at least one processor 1235, the at least one processor 1235 and the at least one memory 1225 configured to perform various functions described herein. The at least one processor 1235 may be an example of a cloud-computing platform (e.g., one or more physical nodes and supporting software such as operating systems, virtual machines, or container instances) that may host the functions (e.g., by executing code 1230) to perform the functions of the device 1205. The at least one processor 1235 may be any one or more suitable processors capable of executing scripts or instructions of one or more software programs stored in the device 1205 (such as within one or more of the at least one memory 1225).

In some examples, the at least one processor 1235 may include multiple processors and the at least one memory 1225 may include multiple memories. One or more of the multiple processors may be coupled with one or more of the multiple memories, which may, individually or collectively, be configured to perform various functions herein. In some examples, the at least one processor 1235 may be a component of a processing system, which may refer to a system (such as a series) of machines, circuitry (including, for example, one or both of processor circuitry (which may include the at least one processor 1235) and memory circuitry (which may include the at least one memory 1225)), or components, that receives or obtains inputs and processes the inputs to produce, generate, or obtain a set of outputs. The processing system may be configured to perform one or more of the functions described herein. For example, the at least one processor 1235 or a processing system including the at least one processor 1235 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code stored in the at least one memory 1225 or otherwise, to perform one or more of the functions described herein.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the at least one memory 1225, the code 1230, and the at least one processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with one or more other network entities 105, and may include a controller or scheduler for controlling communications with UEs 115 (e.g., in cooperation with the one or more other network devices). In some examples, the communications manager 1220 may support an X2 interface within an LTE/LTE-A wireless communications network technology to provide communication between network entities 105.

The communications manager 1220 may support wireless communication in accordance with examples as disclosed herein. For example, the communications manager 1220 is capable of, configured to, or operable to support a means for outputting a first DCI that schedules a first downlink shared channel transmission, where the first DCI indicates a first DAI value for first feedback information associated with the first downlink shared channel transmission. The communications manager 1220 is capable of, configured to, or operable to support a means for obtaining, during a first uplink channel transmission occasion and based on the first DAI value, a first payload that includes the first feedback information for the first downlink shared channel transmission at a first location of a first codebook. The communications manager 1220 is capable of, configured to, or operable to support a means for outputting a second DCI that schedules a second downlink shared channel transmission, where the second DCI indicates a second DAI value for second feedback information associated with the second downlink shared channel transmission. The communications manager 1220 is capable of, configured to, or operable to support a means for obtaining, during a second uplink channel transmission occasion and based on the first DAI value and the second DAI value, a second payload that includes the first feedback information at a second location of a second codebook and the second feedback information at a third location of a third codebook, where the second payload includes the second codebook concatenated with the third codebook.

By including or configuring the communications manager 1220 in accordance with examples as described herein, the device 1205 may support techniques for dynamic codebook for mapping feedback to multiple slots, which may result in improved communication reliability, reduced latency, improved user experience related to reduced processing, reduced power consumption, reduced restrictions for uplink channel transmission, improved coordination between devices, improved utilization of processing capability and more efficient utilization of communication resources, among other advantages.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, one or more of the at least one processor 1235, one or more of the at least one memory 1225, the code 1230, or any combination thereof (for example, by a processing system including at least a portion of the at least one processor 1235, the at least one memory 1225, the code 1230, or any combination thereof). For example, the code 1230 may include instructions executable by one or more of the at least one processor 1235 to cause the device 1205 to perform various aspects of dynamic codebook for mapping feedback to multiple slots as described herein, or the at least one processor 1235 and the at least one memory 1225 may be otherwise configured to, individually or collectively, perform or support such operations.

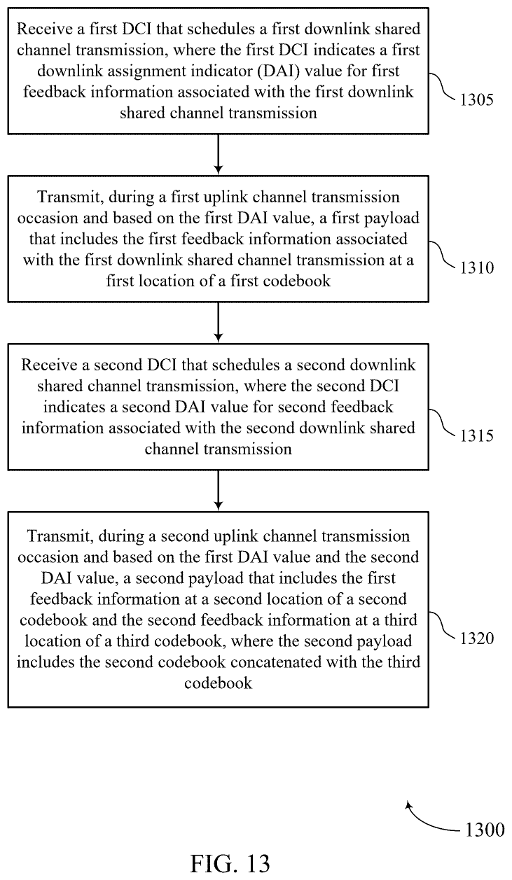

FIG. 13 shows a flowchart illustrating a method 1300 that supports dynamic codebook for mapping feedback to multiple slots in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include receiving a first DCI that schedules a first downlink shared channel transmission, where the first DCI indicates a first DAI value for first feedback information associated with the first downlink shared channel transmission. The operations of 1305 may be performed in accordance with examples as disclosed herein. In some examples, aspects of the operations of 1305 may be performed by a DCI component 725 as described with reference to FIG. 7.

At 1310, the method may include transmitting, during a first uplink channel transmission occasion and based on the first DAI value, a first payload that includes the first feedback information associated with the first downlink shared channel transmission at a first location of a first codebook. The operations of 1310 may be performed in accordance with examples as disclosed herein. In some examples, aspects of the operations of 1310 may be performed by a feedback component 730 as described with reference to FIG. 7.

At 1315, the method may include receiving a second DCI that schedules a second downlink shared channel transmission, where the second DCI indicates a second DAI value for second feedback information associated with the second downlink shared channel transmission. The operations of 1315 may be performed in accordance with examples as disclosed herein. In some examples, aspects of the operations of 1315 may be performed by a DCI component 725 as described with reference to FIG. 7.

At 1320, the method may include transmitting, during a second uplink channel transmission occasion and based on the first DAI value and the second DAI value, a second payload that includes the first feedback information at a second location of a second codebook and the second feedback information at a third location of a third codebook, where the second payload includes the second codebook concatenated with the third codebook. The operations of 1320 may be performed in accordance with examples as disclosed herein. In some examples, aspects of the operations of 1320 may be performed by a second feedback component 735 as described with reference to FIG. 7.

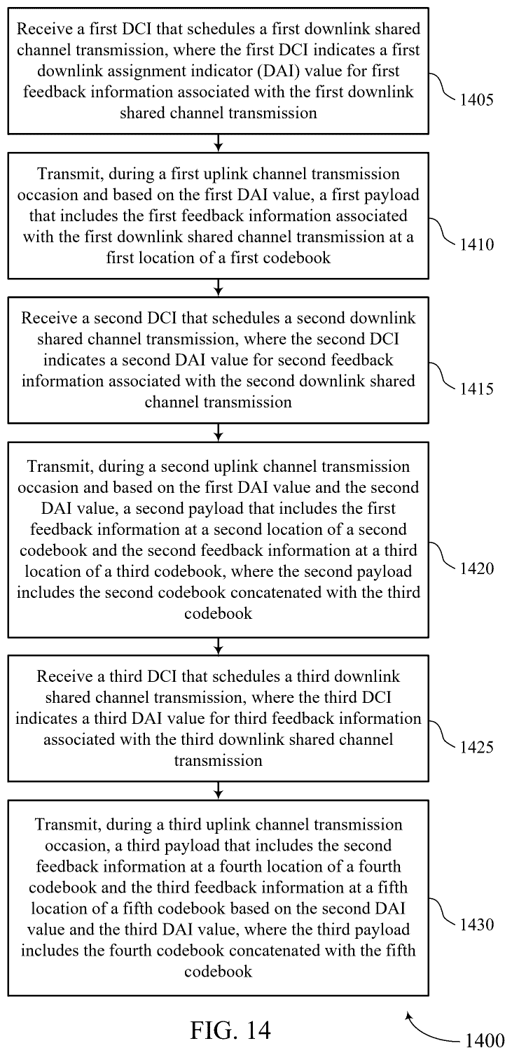

FIG. 14 shows a flowchart illustrating a method 1400 that supports dynamic codebook for mapping feedback to multiple slots in accordance with one or more aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include receiving a first DCI that schedules a first downlink shared channel transmission, where the first DCI indicates a first DAI value for first feedback information associated with the first downlink shared channel transmission. The operations of 1405 may be performed in accordance with examples as disclosed herein. In some examples, aspects of the operations of 1405 may be performed by a DCI component 725 as described with reference to FIG. 7.

At 1410, the method may include transmitting, during a first uplink channel transmission occasion and based on the first DAI value, a first payload that includes the first feedback information associated with the first downlink shared channel transmission at a first location of a first codebook. The operations of 1410 may be performed in accordance with examples as disclosed herein. In some examples, aspects of the operations of 1410 may be performed by a feedback component 730 as described with reference to FIG. 7.

At 1415, the method may include receiving a second DCI that schedules a second downlink shared channel transmission, where the second DCI indicates a second DAI value for second feedback information associated with the second downlink shared channel transmission. The operations of 1415 may be performed in accordance with examples as disclosed herein. In some examples, aspects of the operations of 1415 may be performed by a DCI component 725 as described with reference to FIG. 7.

At 1420, the method may include transmitting, during a second uplink channel transmission occasion and based on the first DAI value and the second DAI value, a second payload that includes the first feedback information at a second location of a second codebook and the second feedback information at a third location of a third codebook, where the second payload includes the second codebook concatenated with the third codebook. The operations of 1420 may be performed in accordance with examples as disclosed herein. In some examples, aspects of the operations of 1420 may be performed by a second feedback component 735 as described with reference to FIG. 7.

At 1425, the method may include receiving a third DCI that schedules a third downlink shared channel transmission, where the third DCI indicates a third DAI value for third feedback information associated with the third downlink shared channel transmission. The operations of 1425 may be performed in accordance with examples as disclosed herein. In some examples, aspects of the operations of 1425 may be performed by a DCI component 725 as described with reference to FIG. 7.

At 1430, the method may include transmitting, during a third uplink channel transmission occasion, a third payload that includes the second feedback information at a fourth location of a fourth codebook and the third feedback information at a fifth location of a fifth codebook based on the second DAI value and the third DAI value, where the third payload includes the fourth codebook concatenated with the fifth codebook. The operations of 1430 may be performed in accordance with examples as disclosed herein. In some examples, aspects of the operations of 1430 may be performed by a third feedback component 740 as described with reference to FIG. 7.

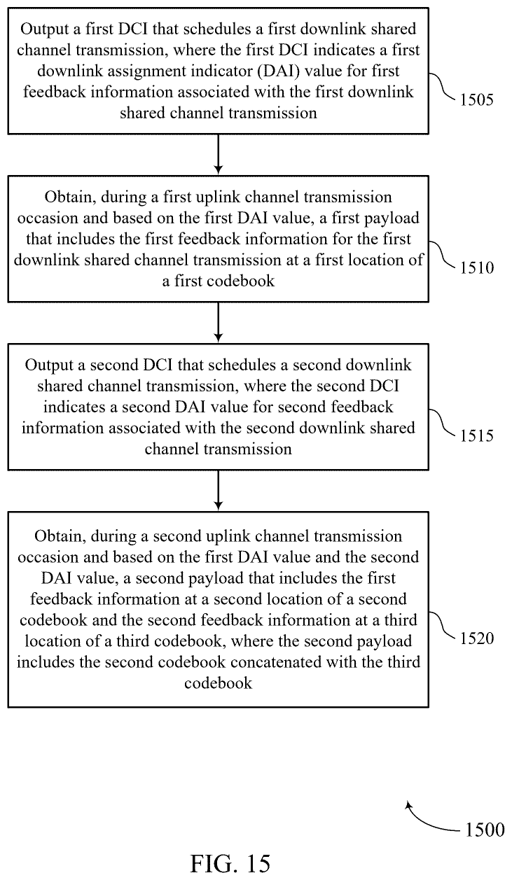

FIG. 15 shows a flowchart illustrating a method 1500 that supports dynamic codebook for mapping feedback to multiple slots in accordance with one or more aspects of the present disclosure. The operations of the method 1500 may be implemented by a network entity or its components as described herein. For example, the operations of the method 1500 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1505, the method may include outputting a first DCI that schedules a first downlink shared channel transmission, where the first DCI indicates a first DAI value for first feedback information associated with the first downlink shared channel transmission. The operations of 1505 may be performed in accordance with examples as disclosed herein. In some examples, aspects of the operations of 1505 may be performed by a DCI manager 1125 as described with reference to FIG. 11.

At 1510, the method may include obtaining, during a first uplink channel transmission occasion and based on the first DAI value, a first payload that includes the first feedback information for the first downlink shared channel transmission at a first location of a first codebook. The operations of 1510 may be performed in accordance with examples as disclosed herein. In some examples, aspects of the operations of 1510 may be performed by a feedback manager 1130 as described with reference to FIG. 11.

At 1515, the method may include outputting a second DCI that schedules a second downlink shared channel transmission, where the second DCI indicates a second DAI value for second feedback information associated with the second downlink shared channel transmission. The operations of 1515 may be performed in accordance with examples as disclosed herein. In some examples, aspects of the operations of 1515 may be performed by a DCI manager 1125 as described with reference to FIG. 11.

At 1520, the method may include obtaining, during a second uplink channel transmission occasion and based on the first DAI value and the second DAI value, a second payload that includes the first feedback information at a second location of a second codebook and the second feedback information at a third location of a third codebook, where the second payload includes the second codebook concatenated with the third codebook. The operations of 1520 may be performed in accordance with examples as disclosed herein. In some examples, aspects of the operations of 1520 may be performed by a second feedback manager 1135 as described with reference to FIG. 11.

The following provides an overview of aspects of the present disclosure:

Aspect 1: A method of wireless communication performed by a network entity, comprising: receiving a first DCI that schedules a first downlink shared channel transmission, wherein the first DCI indicates a first DAI value for first feedback information associated with the first downlink shared channel transmission; transmitting, during a first uplink channel transmission occasion and based on the first DAI value, a first payload that includes the first feedback information associated with the first downlink shared channel transmission at a first location of a first codebook; receiving a second DCI that schedules a second downlink shared channel transmission, wherein the second DCI indicates a second DAI value for second feedback information associated with the second downlink shared channel transmission; and transmitting, during a second uplink channel transmission occasion and based on the first DAI value and the second DAI value, a second payload that includes the first feedback information at a second location of a second codebook and the second feedback information at a third location of a third codebook, wherein the second payload includes the second codebook concatenated with the third codebook.

Aspect 2: The method of aspect 1, wherein the first DAI value indicates a first location of the first feedback information within the first uplink channel transmission occasion, and the second DAI value indicates a second location of the second feedback information within the second uplink channel transmission occasion.

Aspect 3: The method of any of aspects 1 through 2, wherein the first DAI value indicates a location of the first feedback information within the second uplink channel transmission occasion.

Aspect 4: The method of any of aspects 1 through 3, wherein the second payload includes the second feedback information concatenated to an end of the first feedback information.

Aspect 5: The method of any of aspects 1 through 4, wherein the second payload includes the second feedback information concatenated to a beginning of the first feedback information.

Aspect 6: The method of any of aspects 1 through 5, wherein the second payload comprises the second codebook that includes a second report of the first feedback information and the third codebook that includes a first report of the second feedback information.

Aspect 7: The method of any of aspects 1 through 6, wherein the first DCI indicates a set of DAI values comprising the first DAI value and a third DAI value, and the third DAI value is associated with the second uplink channel transmission occasion.

Aspect 8: The method of any of aspects 1 through 7, further comprising: receiving a third DCI that schedules a third downlink shared channel transmission, wherein the third DCI indicates a third DAI value for third feedback information associated with the third downlink shared channel transmission; and transmitting, during a third uplink channel transmission occasion, a third payload that includes the second feedback information at a fourth location of a fourth codebook and the third feedback information at a fifth location of a fifth codebook based on the second DAI value and the third DAI value, wherein the third payload includes the fourth codebook concatenated with the fifth codebook.

Aspect 9: The method of aspect 8, wherein a location of the third feedback information within the third uplink channel transmission occasion is based on a difference between the third DAI value and a highest DAI value among a set of DAI values associated with the first payload.

Aspect 10: The method of any of aspects 1 through 9, wherein the second DAI value corresponds to a location of the second feedback information within a subset of feedback bits of the second payload.

Aspect 11: The method of any of aspects 1 through 10, wherein the second DAI value corresponds to a location of the second feedback information within all feedback bits of the second payload.

Aspect 12: The method of any of aspects 1 through 11, wherein an ordering of the first feedback information within the first uplink channel transmission occasion is based on a timing of a set of DCI that schedules a downlink shared channel transmission, including the first DCI that schedules the first downlink shared channel transmission.

Aspect 13: A method of wireless communication performed by a network entity, comprising: outputting a first DCI that schedules a first downlink shared channel transmission, wherein the first DCI indicates a first DAI value for first feedback information associated with the first downlink shared channel transmission; obtaining, during a first uplink channel transmission occasion and based on the first DAI value, a first payload that includes the first feedback information for the first downlink shared channel transmission at a first location of a first codebook; outputting a second DCI that schedules a second downlink shared channel transmission, wherein the second DCI indicates a second DAI value for second feedback information associated with the second downlink shared channel transmission; and obtaining, during a second uplink channel transmission occasion and based on the first DAI value and the second DAI value, a second payload that includes the first feedback information at a second location of a second codebook and the second feedback information at a third location of a third codebook, wherein the second payload includes the second codebook concatenated with the third codebook.

Aspect 14: The method of aspect 13, wherein the first DAI value indicates a first location of the first feedback information within the first uplink channel transmission occasion, and the second DAI value indicates a second location of the second feedback information within the second uplink channel transmission occasion.

Aspect 15: The method of any of aspects 13 through 14, wherein the first DAI value indicates a location of the first feedback information within the second uplink channel transmission occasion.

Aspect 16: The method of any of aspects 13 through 15, wherein the second payload includes the second feedback information concatenated to an end of the first feedback information.

Aspect 17: The method of any of aspects 13 through 16, wherein the second payload includes the second feedback information concatenated to a beginning of the first feedback information.

Aspect 18: The method of any of aspects 13 through 17, wherein the second payload comprises the second codebook that includes a second report of the first feedback information and the third codebook that includes a first report of the second feedback information.

Aspect 19: The method of any of aspects 13 through 18, wherein the first DCI indicates a set of DAI values comprising the first DAI value and a third DAI value, and the third DAI value is associated with the second uplink channel transmission occasion.

Aspect 20: The method of any of aspects 13 through 19, further comprising: outputting a third DCI that schedules a third downlink shared channel transmission, wherein the third DCI indicates a third DAI value for third feedback information associated with the third downlink shared channel transmission; and obtaining, during a third uplink channel transmission occasion, a third payload that includes the second feedback information at a fourth location of a fourth codebook and the third feedback information at a fifth location of a fifth codebook based on the second DAI value and the third DAI value, wherein the third payload includes the fourth codebook concatenated with the fifth codebook.

Aspect 21: The method of aspect 20, wherein a location of the third feedback information within the third uplink channel transmission occasion is based on a difference between the third DAI value and a highest DAI value among a set of DAI values associated with the first payload.

Aspect 22: The method of any of aspects 13 through 21, wherein the second DAI value corresponds to a location of the second feedback information within a subset of feedback bits of the second payload.

Aspect 23: The method of any of aspects 13 through 22, wherein the second DAI value corresponds to a location of the second feedback information within all feedback bits of the second payload.

Aspect 24: The method of any of aspects 13 through 23, wherein an ordering of the first feedback information within the first uplink channel transmission occasion is based on a timing of a set of DCI that schedules a downlink shared channel transmission, including the first DCI that schedules the first downlink shared channel transmission.

Aspect 25: A network entity for wireless communication, comprising one or more memories storing processor-executable code, and one or more processors coupled with the one or more memories and individually or collectively operable to execute the code to cause the network entity to perform a method of any of aspects 1 through 12.

Aspect 26: A network entity for wireless communication, comprising at least one means for performing a method of any of aspects 1 through 12.

Aspect 27: A non-transitory computer-readable medium storing code for wireless communication, the code comprising instructions executable by one or more processors to perform a method of any of aspects 1 through 12.

Aspect 28: A network entity for wireless communication, comprising one or more memories storing processor-executable code, and one or more processors coupled with the one or more memories and individually or collectively operable to execute the code to cause the network entity to perform a method of any of aspects 13 through 24.

Aspect 29: A network entity for wireless communication, comprising at least one means for performing a method of any of aspects 13 through 24.

Aspect 30: A non-transitory computer-readable medium storing code for wireless communication, the code comprising instructions executable by one or more processors to perform a method of any of aspects 13 through 24.

The methods described herein describe possible implementations, and the operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, the term “or” is an inclusive “or” unless limiting language is used relative to the alternatives listed. For example, reference to “X being based on A or B” shall be construed as including within its scope X being based on A, X being based on B, and X being based on A and B. In this regard, reference to “X being based on A or B” refers to “at least one of A or B” or “one or more of A or B” due to “or” being inclusive. Similarly, reference to “X being based on A, B, or C” shall be construed as including within its scope X being based on A, X being based on B, X being based on C, X being based on A and B, X being based on A and C, X being based on B and C, and X being based on A, B, and C. In this regard, reference to “X being based on A, B, or C” refers to “at least one of A, B, or C” or “one or more of A, B, or C” due to “or” being inclusive. As an example of limiting language, reference to “X being based on only one of A or B” shall be construed as including within its scope X being based on A as well as X being based on B, but not X being based on A and B. Also, as used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently. Also, as used herein, the phrase “a set” shall be construed as including the possibility of a set with one member. That is, the phrase “a set” shall be construed in the same manner as “one or more” or “at least one of.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the drawings, describes example configurations and does not represent all the examples that may be implemented or that are within the scope of the claims. The term “aspect” or “example” used herein means “serving as an aspect, example, instance, or illustration” and not “preferred” or “advantageous over other aspects.” The detailed description includes specific details for the purpose of providing an understanding of the described techniques. These techniques, however, may be practiced without these specific details. In some figures, structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A network entity, comprising:
a processing system configured to:
receive a first downlink control information (DCI) that schedules a first downlink shared channel transmission, wherein the first DCI indicates a first downlink assignment indicator (DAI) value for first feedback information associated with the first downlink shared channel transmission;
transmit, during a first uplink channel transmission occasion and based on the first DAI value, a first payload that includes the first feedback information associated with the first downlink shared channel transmission at a first location of a first codebook;
receive a second DCI that schedules a second downlink shared channel transmission, wherein the second DCI indicates a second DAI value for second feedback information associated with the second downlink shared channel transmission; and
transmit, during a second uplink channel transmission occasion and based on the first DAI value and the second DAI value, a second payload that includes the first feedback information at a second location of a second codebook and the second feedback information at a third location of a third codebook, wherein the second payload includes the second codebook concatenated with the third codebook.

2. The network entity of claim 1, wherein:
the first DAI value indicates a first location of the first feedback information within the first uplink channel transmission occasion, and
the second DAI value indicates a second location of the second feedback information within the second uplink channel transmission occasion.

3. The network entity of claim 1, wherein the first DAI value indicates a location of the first feedback information within the second uplink channel transmission occasion.

4. The network entity of claim 1, wherein the second payload includes the second feedback information concatenated to an end of the first feedback information.

5. The network entity of claim 1, wherein the second payload includes the second feedback information concatenated to a beginning of the first feedback information.

6. The network entity of claim 1, wherein the second payload comprises the second codebook that includes a second report of the first feedback information and the third codebook that includes a first report of the second feedback information.

7. The network entity of claim 1, wherein:
the first DCI indicates a set of DAI values comprising the first DAI value and a third DAI value, and
the third DAI value is associated with the second uplink channel transmission occasion.

8. The network entity of claim 1, wherein the processing system is configured to:
receive a third DCI that schedules a third downlink shared channel transmission, wherein the third DCI indicates a third DAI value for third feedback information associated with the third downlink shared channel transmission; and
transmit, during a third uplink channel transmission occasion, a third payload that includes the second feedback information at a fourth location of a fourth codebook and the third feedback information at a fifth location of a fifth codebook based on the second DAI value and the third DAI value, wherein the third payload includes the fourth codebook concatenated with the fifth codebook.

9. The network entity of claim 8, wherein a location of the third feedback information within the third uplink channel transmission occasion is based on a difference between the third DAI value and a highest DAI value among a set of DAI values associated with the first payload.

10. The network entity of claim 1, wherein the second DAI value corresponds to a location of the second feedback information within a subset of feedback bits of the second payload.

11. The network entity of claim 1, wherein the second DAI value corresponds to a location of the second feedback information within all feedback bits of the second payload.

12. The network entity of claim 1, wherein an ordering of the first feedback information within the first uplink channel transmission occasion is based on a timing of a set of DCI that schedules a downlink shared channel transmission, including the first DCI that schedules the first downlink shared channel transmission.

13. A network entity, comprising:
a processing system configured to:
output a first downlink control information (DCI) that schedules a first downlink shared channel transmission, wherein the first DCI indicates a first downlink assignment indicator (DAI) value for first feedback information associated with the first downlink shared channel transmission;
obtain, during a first uplink channel transmission occasion and based on the first DAI value, a first payload that includes the first feedback information for the first downlink shared channel transmission at a first location of a first codebook;
output a second DCI that schedules a second downlink shared channel transmission, wherein the second DCI indicates a second DAI value for second feedback information associated with the second downlink shared channel transmission; and
obtain, during a second uplink channel transmission occasion and based on the first DAI value and the second DAI value, a second payload that includes the first feedback information at a second location of a second codebook and the second feedback information at a third location of a third codebook, wherein the second payload includes the second codebook concatenated with the third codebook.

14. The network entity of claim 13, wherein:
the first DAI value indicates a first location of the first feedback information within the first uplink channel transmission occasion, and
the second DAI value indicates a second location of the second feedback information within the second uplink channel transmission occasion.

15. The network entity of claim 13, wherein the first DAI value indicates a location of the first feedback information within the second uplink channel transmission occasion.

16. The network entity of claim 13, wherein the second payload includes the second feedback information concatenated to an end of the first feedback information.

17. The network entity of claim 13, wherein the second payload includes the second feedback information concatenated to a beginning of the first feedback information.

18. The network entity of claim 13, wherein the second payload comprises the second codebook that includes a second report of the first feedback information and the third codebook that includes a first report of the second feedback information.

19. The network entity of claim 13, wherein:
the first DCI indicates a set of DAI values comprising the first DAI value and a third DAI value, and
the third DAI value is associated with the second uplink channel transmission occasion.

20. The network entity of claim 13, wherein the processing system is configured to:
output a third DCI that schedule a third downlink shared channel transmission, wherein the third DCI indicates a third DAI value for third feedback information associated with the third downlink shared channel transmission; and
obtain, during a third uplink channel transmission occasion, a third payload that includes the second feedback information at a fourth location of a fourth codebook and the third feedback information at a fifth location of a fifth codebook based on the second DAI value and the third DAI value, wherein the third payload includes the fourth codebook concatenated with the fifth codebook.

21. The network entity of claim 20, wherein a location of the third feedback information within the third uplink channel transmission occasion is based on a difference between the third DAI value and a highest DAI value among a set of DAI values associated with the first payload.

22. The network entity of claim 13, wherein the second DAI value corresponds to a location of the second feedback information within a subset of feedback bits of the second payload.

23. The network entity of claim 13, wherein the second DAI value corresponds to a location of the second feedback information within all feedback bits of the second payload.

24. The network entity of claim 13, wherein an ordering of the first feedback information within the first uplink channel transmission occasion is based on a timing of a set of DCI that schedules a downlink shared channel transmission, including the first DCI that schedules the first downlink shared channel transmission.

25. A method of wireless communication performed by a network entity, comprising:
receiving a first downlink control information (DCI) that schedules a first downlink shared channel transmission, wherein the first DCI indicates a first downlink assignment indicator (DAI) value for first feedback information associated with the first downlink shared channel transmission;
transmitting, during a first uplink channel transmission occasion and based on the first DAI value, a first payload that includes the first feedback information associated with the first downlink shared channel transmission at a first location of a first codebook;
receiving a second DCI that schedules a second downlink shared channel transmission, wherein the second DCI indicates a second DAI value for second feedback information associated with the second downlink shared channel transmission; and
transmitting, during a second uplink channel transmission occasion and based on the first DAI value and the second DAI value, a second payload that includes the first feedback information at a second location of a second codebook and the second feedback information at a third location of a third codebook, wherein the second payload includes the second codebook concatenated with the third codebook.

26. The method of claim 25, wherein:
the first DAI value indicates a first location of the first feedback information within the first uplink channel transmission occasion, and
the second DAI value indicates a second location of the second feedback information within the second uplink channel transmission occasion.

27. The method of claim 25, further comprising:
receiving a third DCI that schedules a third downlink shared channel transmission, wherein the third DCI indicates a third DAI value for third feedback information associated with the third downlink shared channel transmission; and
transmitting, during a third uplink channel transmission occasion, a third payload that includes the second feedback information at a fourth location of a fourth codebook and the third feedback information at a fifth location of a fifth codebook based on the second DAI value and the third DAI value, wherein the third payload includes the fourth codebook concatenated with the fifth codebook.

28. A method of wireless communication performed by a network entity, comprising:
outputting a first downlink control information (DCI) that schedules a first downlink shared channel transmission, wherein the first DCI indicates a first downlink assignment indicator (DAI) value for first feedback information associated with the first downlink shared channel transmission;
obtaining, during a first uplink channel transmission occasion and based on the first DAI value, a first payload that includes the first feedback information for the first downlink shared channel transmission at a first location of a first codebook;
outputting a second DCI that schedules a second downlink shared channel transmission, wherein the second DCI indicates a second DAI value for second feedback information associated with the second downlink shared channel transmission; and
obtaining, during a second uplink channel transmission occasion and based on the first DAI value and the second DAI value, a second payload that includes the first feedback information at a second location of a second codebook and the second feedback information at a third location of a third codebook, wherein the second payload includes the second codebook concatenated with the third codebook.

29. The method of claim 28, wherein:
the first DAI value indicates a first location of the first feedback information within the first uplink channel transmission occasion, and
the second DAI value indicates a second location of the second feedback information within the second uplink channel transmission occasion.

30. The method of claim 28, further comprising:
outputting a third DCI that schedules a third downlink shared channel transmission, wherein the third DCI indicates a third DAI value for third feedback information associated with the third downlink shared channel transmission; and
obtaining, during a third uplink channel transmission occasion, a third payload that includes the second feedback information at a fourth location of a fourth codebook and the third feedback information at a fifth location of a fifth codebook based on the second DAI value and the third DAI value, wherein the third payload includes the fourth codebook concatenated with the fifth codebook.
